(19) United States
(12) Patent Application Publication
(10) Pub. No.: US 2013/0336811 A1
(43) Pub. Date: Dec. 19, 2013

(54) ROTOR APPARATUS

(71) Applicants: Norbert Müller, Haslett, MI (US); Janusz Piechna, Warsaw (PL)

(72) Inventors: Norbert Müller, Haslett, MI (US); Janusz Piechna, Warsaw (PL)

(73) Assignee: BOARD OF TRUSTEES OF MICHIGAN STATE UNIVERSITY, East Lansing, MI (US)

(21) Appl. No.: 14/001,820

(22) PCT Filed: Feb. 28, 2012
(86) PCT No.: PCT/US2012/026932

§ 371 Date: Aug. 27, 2013

Related U.S. Application Data
(60) Provisional application No. 61/447,404, filed on Feb. 28, 2011.

(51) Int. Cl. F01D 5/04

(52) U.S. Cl. CPC F01D 5/04
USPC 417/53; 416/229 R; 417/420

(57) ABSTRACT

A rotor apparatus is provided. In another aspect, a woven and/or stacked fiber rotor or impeller is used for a water turbine. A further aspect provides a woven and/or stacked fiber rotor or impeller used for a wind turbine. In

still another aspect, a woven and/or stacked fiber rotor or impeller is used for a natural gas compressor. In another aspect, a woven and/or stacked fiber rotor or impeller is used for a geothermal noncondensable gas compressor.

### CROSS-REFERENCE TO RELATED APPLICATIONS

This application claims priority to U.S. Provisional Patent Application Ser. No. 61/447,404, filed on Feb. 28, 2011, which is incorporated by reference herein.

### BACKGROUND AND SUMMARY

The present invention generally pertains to rotors and more particularly to a rotor apparatus with one or more fibers.

It is known to use a drive or driven wheel in water turbines. It is also known to employ rotating blades and shafts in airborne wind turbines. Examples of such traditional devices are disclosed in U.S. Patent Publication Nos.: 2011/0044819 entitled “Water Turbine Drive Wheel;” 2010/0276942 entitled “Electrical Power Generation from Fluid Flow;” 2010/0066089 entitled “Subsea Turbine with a Peripheral Drive;” and 2010/0066095 entitled “Airborne Stabilized Wind Turbines System;” all of which are incorporated by reference herein. Typically, such blades are metal or vacuum bagged, composite sheets, which are undesireably heavy and/or expensive to manufacture.

In accordance with the present invention, a rotor apparatus is provided. In another aspect, a woven and/or stacked fiber rotor or impeller is used for a water turbine. A further aspect provides a woven and/or stacked fiber rotor or impeller used for a wind turbine. In still another aspect, a woven and/or stacked fiber rotor or impeller is used for a natural gas compressor. In another aspect, a woven and/or stacked fiber rotor or impeller is used for a geothermal noncondensable gas (“NCG”) compressor. In another aspect, a woven and/or stacked fiber rotor or impeller is used for desalination of water. In another aspect, a woven and/or stacked fiber rotor or impeller is used for water purification. In a further aspect, a woven and/or stacked fiber rotor or impeller is used for a waste water treatment. Moreover, another aspect integrates a woven and/or stacked fiber rotor or impeller to a structure such as a building roof and/or wall, tower, bridge, fence or the like. Methods of using a woven and/or stacked fiber rotor or impeller for the above aspects are also disclosed.

The present rotor apparatus is advantageous over conventional rotors, since the present fiber rotor is considerably lighter weight which requires less energy to rotate and can rotate at greater speeds since centrifugal forces are less likely to damage the fiber and resin blades and shroud. Furthermore, the present rotor is less expensive to manufacture and can be manufactured without expensive dedicated tooling. In another aspect, the fiber and resin rotor is corrosion resistant which is especially helpful in handling the corrosive fluids present in geothermal, natural gas, petroleum and chemical use. An additional aspect advantageously provides modularization of the rotor and stator assembly for easier assembly and maintenance. Rotor bearing cooling is also advantageously provided which allows for greater rotational speeds without overheating, such as through coolant sprays, integrated water jackets and/or water lubricated bearings. Moreover, the lighter weight fiber rotor is ideally suited for airborne and floating in or on water use. Additional advantages and features will be observed from the following description and claims, as well as in the appended figures.

### BRIEF DESCRIPTION OF THE DRAWINGS

FIGS. 1A-1D are a series of perspective views showing manufacturing steps to make one configuration of a rotor employed in a rotor apparatus used with any of the present embodiments of the present invention;

FIG. 2 is a perspective view showing a manufacturing jig used to make the rotor of FIG. 19 of the rotor apparatus;

FIG. 3 is a true elevational view showing a different configuration rotor of the rotor apparatus used with any of the present embodiments;

FIG. 4 is a diagrammatic view showing a manufacturing process of a different configuration rotor of the rotor apparatus used in any of the present embodiments;

FIG. 5 is a perspective view showing a different configuration rotor of the rotor apparatus used with any of the present embodiments;

FIG. 6 is a true elevational view showing the rotor of FIG. 5 of the rotor apparatus;

FIG. 7 is a perspective view showing a different configuration rotor of the rotor apparatus used with any of the present embodiments;

FIG. 8 is a true elevational view showing the rotor of FIG. 7 of the rotor apparatus;

FIG. 9 is a perspective view showing a different configuration rotor of the rotor apparatus used in any of the present embodiments;

FIGS. 10A-10C are a series of true elevational views showing the manufacturing steps of the rotor of FIG. 9 of the rotor apparatus;

FIG. 11 is a cross-sectional view, taken along line 11-11 of FIG. 10D, showing the rotor of the rotor apparatus;

FIG. 12 is a diagrammatic view showing the FIG. 4 configuration of the rotor apparatus used in any of the present embodiments;

FIG. 13 is a diagrammatic cross-sectional view showing a different configuration for a rotor employed in the rotor apparatus used with any of the present embodiments;

FIG. 14 is a side perspective view showing another embodiment of the rotor apparatus;

FIG. 15 is a side elevational view showing the FIG. 14 embodiment of the rotor apparatus;

FIG. 16 is a top perspective view showing the FIG. 14 embodiment of the rotor apparatus;

FIG. 17 is a top perspective view showing the FIG. 14 embodiment of the rotor apparatus, with a module pivoted to the side;

FIG. 18 is an end elevational view showing the FIG. 14 embodiment of the rotor apparatus;

FIG. 19 is an end elevational view showing a rotor employed in the rotor apparatus used in the FIG. 14 embodiment;

FIG. 20 is a perspective view showing a stator of the rotor apparatus of FIG. 15;

FIG. 21 is a perspective view showing the rotor apparatus used in another embodiment;

FIG. 22 is a side elevational view showing the rotor apparatus used in the FIG. 21 embodiment;

FIG. 23 is an assembled perspective view showing the rotor apparatus used in the FIG. 21 embodiment;

FIG. 24 is a partially exploded perspective view showing the rotor apparatus used in the FIG. 21 embodiment;

FIG. 25 is an assembled perspective view showing the rotor apparatus used in the FIG. 21 embodiment;

FIG. 26 is an exploded perspective view showing rotors of the rotor apparatus used in the FIG. 21 embodiment;

FIG. 27 is an exploded perspective view showing a stator of the rotor apparatus used in the FIG. 21 embodiment;

FIG. 28 is an assembled perspective view showing stators of the rotor apparatus used in the FIG. 21 embodiment;

FIG. 29 is a perspective view showing a portion of the stator of the rotor apparatus used in the FIG. 21 embodiment;

FIG. 30 is a perspective view showing a portion of the stator of the rotor apparatus used in the FIG. 21 embodiment;

FIG. 31 is a perspective view showing a portion of the stator of the rotor apparatus used in the FIG. 21 embodiment;

FIG. 32 is a perspective view showing a portion of the stator of the rotor apparatus used in the FIG. 21 embodiment;

FIG. 33 is a perspective view showing a portion of the stator of the rotor apparatus used in the FIG. 21 embodiment;

FIG. 34 is a cross-sectional view, taking along line 34-34 of FIG. 28, showing the stator of the rotor apparatus;

FIG. 35 is a diagrammatic view showing a different configuration of the rotor apparatus used in natural gas or geothermal embodiments;

FIG. 36 is a diagrammatic view showing the rotor apparatus used in a geothermal embodiment;

FIG. 37 is a diagrammatic side view showing another embodiment of the rotor apparatus;

FIG. 38 is a perspective view showing an outlet structure of the rotor apparatus used in the FIG. 37 embodiment;

FIG. 39 is a perspective view showing an inlet structure of the rotor apparatus used in the FIG. 37 embodiment;

FIG. 40 is a diagrammatic view showing the rotor apparatus used in a different configuration of the geothermal embodiment;

FIG. 41 is a diagrammatic true view showing a cooling conduit of the rotor apparatus used in the geothermal embodiment;

FIG. 42 is a perspective view showing a different cooling conduit of the rotor apparatus used in the geothermal embodiment;

FIG. 43 is a cross-sectional view, taking along line 43-43 of FIG. 42, showing the cooling conduit of the rotor apparatus;

FIG. 44 is a cross-sectional view, like that of FIG. 43, showing another configuration of the cooling conduit of the rotor apparatus;

FIGS. 45A-45C are a series of diagrammatic views showing manufacturing steps to make an encapsulated configuration of a stator employed in the rotor apparatus used with any of the present embodiments;

FIG. 46 is a diagrammatic view showing a different encapsulation configuration stator employed in the rotor apparatus used in any of the present embodiments;

FIG. 47 is a true diagrammatic view showing the rotor apparatus used in a wind turbine embodiment;

FIG. 48 is a true diagrammatic view showing the rotor apparatus used in a different wind turbine embodiment;

FIG. 49 is a diagrammatic side view showing the rotor apparatus used in a different wind or water turbine embodiment;

FIG. 50 is a longitudinally sectioned side view showing the rotor apparatus used in a different wind or water turbine embodiment;

FIG. 51 is a true diagrammatic view showing the rotor apparatus used in a different wind turbine embodiment;

FIG. 52 is a perspective view showing the rotor apparatus used in a different wind turbine embodiment;

FIG. 53 is a true diagrammatic view showing the rotor apparatus used in a different wind turbine and ventilation embodiment;

FIG. 54 is a true diagrammatic view showing the rotor apparatus used in a different wind turbine embodiment;

FIG. 55 is a perspective view showing the rotor apparatus used in a water turbine embodiment;

FIG. 56 is a true elevational view showing the rotor apparatus used in a different water turbine embodiment;

FIG. 57 is a diagrammatic side view showing the rotor apparatus used in a water purification embodiment;

FIG. 58 is a rear perspective view showing the rotor apparatus used in an aircraft embodiment; and

FIG. 59 is a front perspective view showing the rotor apparatus used in the aircraft embodiment.

### DETAILED DESCRIPTION

The following description of the various embodiments is merely exemplary in nature and is in no way intended to limit the invention, its application, or uses. The present invention provides a rotor or impeller apparatus and methods of their use. Furthermore, the present invention provides woven and/or stacked fiber impellers or rotors for use in electrical generators or compressors.

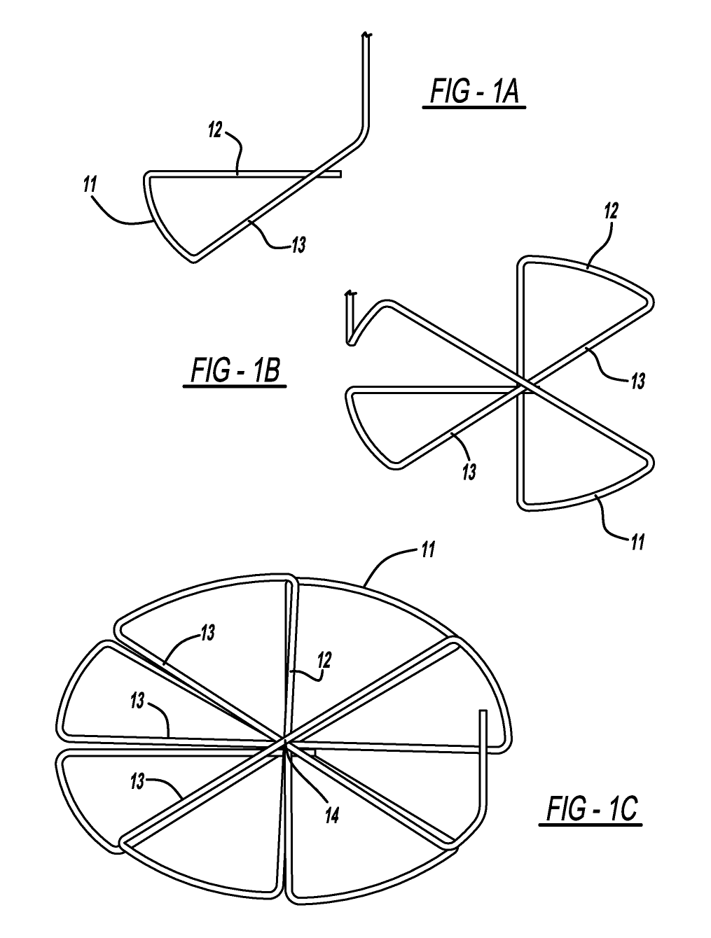

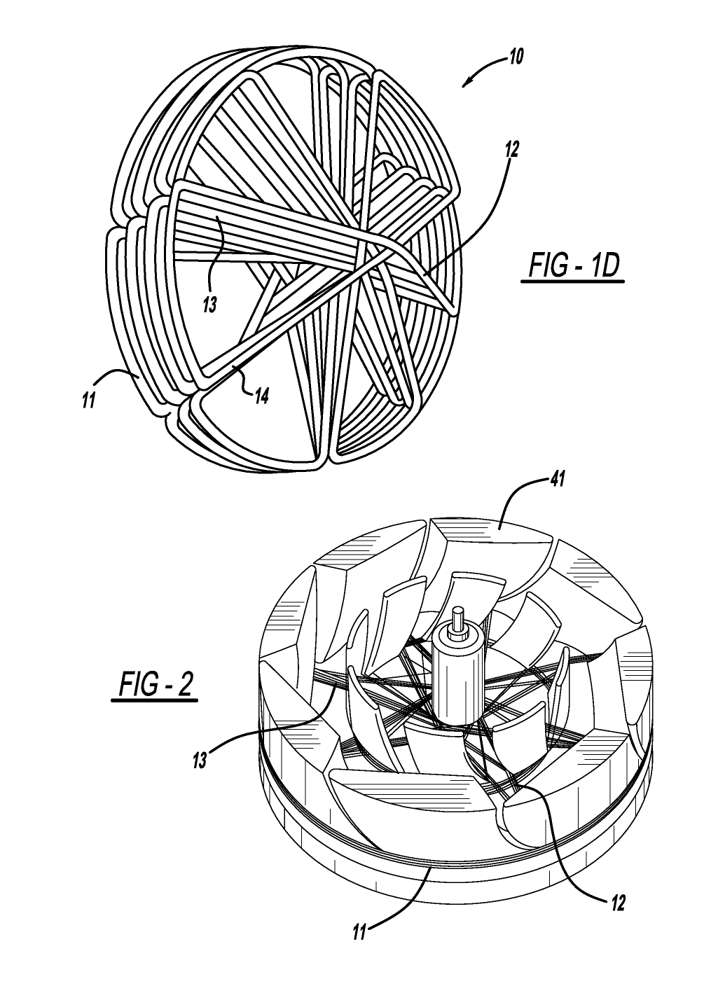

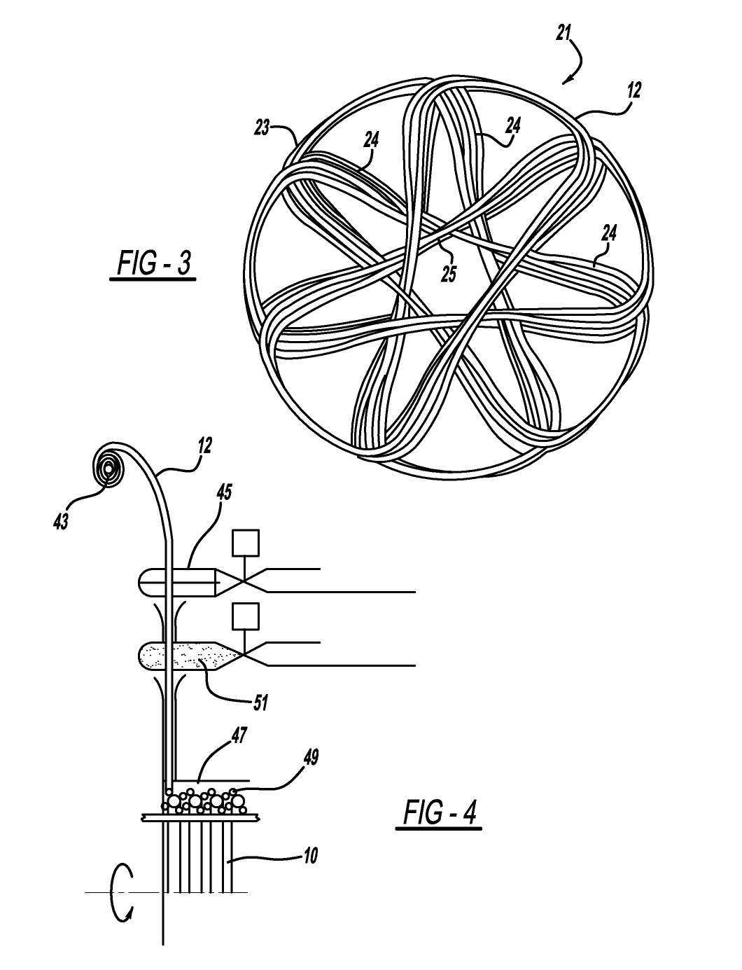

Referring to FIGS. 1A-D, an impeller 10 is woven from a fiber 12 and includes eight blade or vane portions 13 and a duct or shroud portion 11 which surrounds the blades. Fiber 12 is woven to form blades 13 and shroud 11, and fiber 12 crosses in the center 14 with segments thereof overlapping each other. The blades and shroud are made as an integral, single piece. Weaving may be done on a jig 41 (see FIG. 2) designed for such a pattern and woven by hand or preferably the weaving is done on a turn key system such as an automated machine that is designed to create impeller. The weaving pattern as shown in FIGS. 1A-D may be altered to create more or less blades or may be altered to produce the alternative embodiments shown in FIG. 3 or other variations, many of which include a hollow cylindrical center portion 25. The alternative embodiment of FIG. 3 has impeller 21 formed by fiber 12, and has blade portions 24 and a shroud portion 23. Additional uses for the alternative embodiment of FIG. 3 include a drive shaft that may be integrally woven in the area of cylindrical hollow hub 25 as a single piece or a drive shaft or pivot that may be attached in hub 25 to the impeller. Further details and patterns are disclosed in U.S. Patent Publication No. 2007/0297905 entitled “Woven Turbomachine Impeller” invented by Müller, which is incorporated by reference herein.

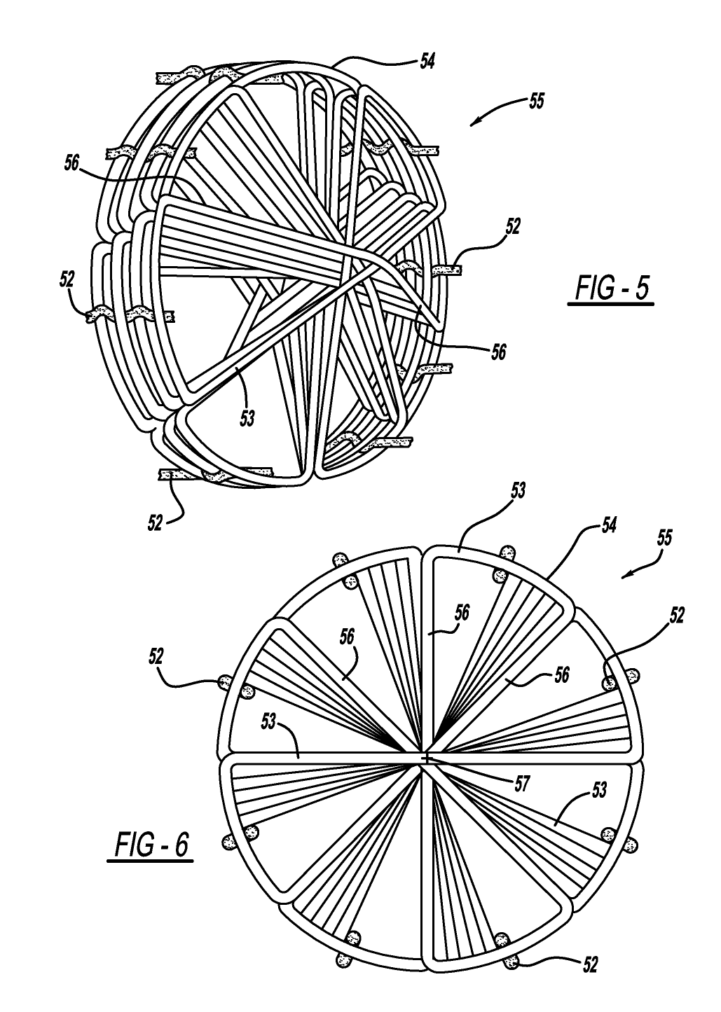

The preferred embodiment process for woven impeller 10 sequentially includes fiber creation, fiber wetting, fiber winding/weaving and curing. Referring to FIGS. 4 and 12, a spool 43 containing continuous fiber 12 is automatically fed into a resin bath 45. The resin bath is preferably a tank containing resin 47 or other coating which will stick to at least the outside of fiber 12. Alternately, resin can be sprayed or otherwise deposited onto fiber 12, or a pre-coated fiber can be used. An alternate manufacturing process uses a first matrix material of pure resin applied to fiber 12 by way of a first tank and dispenser assembly, and a second matrix material with ground reinforcing, magnetic or conductive particles 49, subsequently or simultaneously applied to fiber 12 via a second tank 51 and dispenser assembly on all or selected portions of the wheel. More specifically, resin 47 is added in a liquid or gel form prior to or during the weaving process which is known in the art as “wetting weaving” or “fiber wetting.” The resin is self-hardening so that the woven impeller hardens over time after weaving and then is removed from a jig in a hardened form. Alternately or additionally, heat curing can be provided, employing an oven, blown heat, UV-light, laser heating, lamp heating, or the like. In other embodiments, the resin may be an epoxy type resin such that it has one or two components which create the adhesion or self-hardening. The resin may be hardened by temperature and the woven impeller on a jig may be placed in an oven to enhance hardening. Alternately, the resin may be hardened through use of ultraviolet light. It is noteworthy that a mold is not required, thereby reducing capital expense and manufacturing complexity.

Fiber 12 may be a prefabricated fiber with a PVC coating or other polymeric coating which is on the fiber and has any of the properties and hardening techniques as described above for resins. In any of the above embodiments, the resin, PVC or polymeric material may optionally contain electromagnetic or conductive particles and properties. In another variation, the fiber(s) is woven on a hollow and rigid plastic tube with slots and such a plastic tube becomes part of the impeller, and acts as the primary shroud portion with the fibers acting as the blade portions. The fiber(s) are secured in the slots and may or may not be severed at the tube to avoid sharp-angle turns. The plastic tube may optionally contain magnetic or electromagnetic properties. Alternately, the plastic tube can be a metallic tube that thereafter becomes an induction element for a rotor having an integrated induction-type motor or generator such that electromagnetism is created without the need for expensive permanent magnets. FIG. 12 also illustrates a stator 48 with electrically conductive wire windings 50, concentrically surrounding rotor 12. Windings 50 can also be a conductive carbon fiber in a composite.

In another embodiment as shown in FIGS. 5 and 6, the impeller fiber layers or segments are held together by cross-stitching. The cross-stitching may be a fiber that is similar to that forming the impeller that is woven perpendicular to the vanes. In some of the embodiments, the cross-stitching includes an electromagnetic or conductive fiber 52 that is different than fiber 12. The cross weave may be a fiber 53 made of a Nylon engineering grade polymer or another lightweight and strong material. Impeller 55 may be generally rigid and in other embodiments, it may be generally non-rigid and flexible or pliable.

In this embodiment, impeller 55 has multiple, shorter electromagnetic or conductive fibers 52 generally perpendicularly woven into fibers 53 of peripheral shroud 54, and also may be short-circuited at their ends as a swirl cage for induction type machines. Impeller 55 is formed by weaving fiber 53 thereby creating blades 56, with a centerpoint 57 (coinciding with its rotational axis), and shroud 54 with engaged fibers 52 permanently integrated therein. Fibers 53 and 52 are coated with a resin by wetting. An alternate embodiment employs an induction wire of copper, steel, aluminum, nickel (which is corrosion resistant), or alloys thereof, which surrounds a majority or more of the stacked segment layers of nonconductive, carbon fiber 53 at multiple spaced apart locations of the shroud. A wetted resin coating binds the segments and fibers together.

In embodiments in which the impeller is non-rigid, the woven fiber impeller spins into shape when rotated in a compressor and, when not being rotated, it folds in an umbrella-like manner so that it does not impede fluid flow therepast. Typically, a non-rigid impeller is cross-stitched as opposed to using a hardening resin material on the fiber for a rigid impeller.

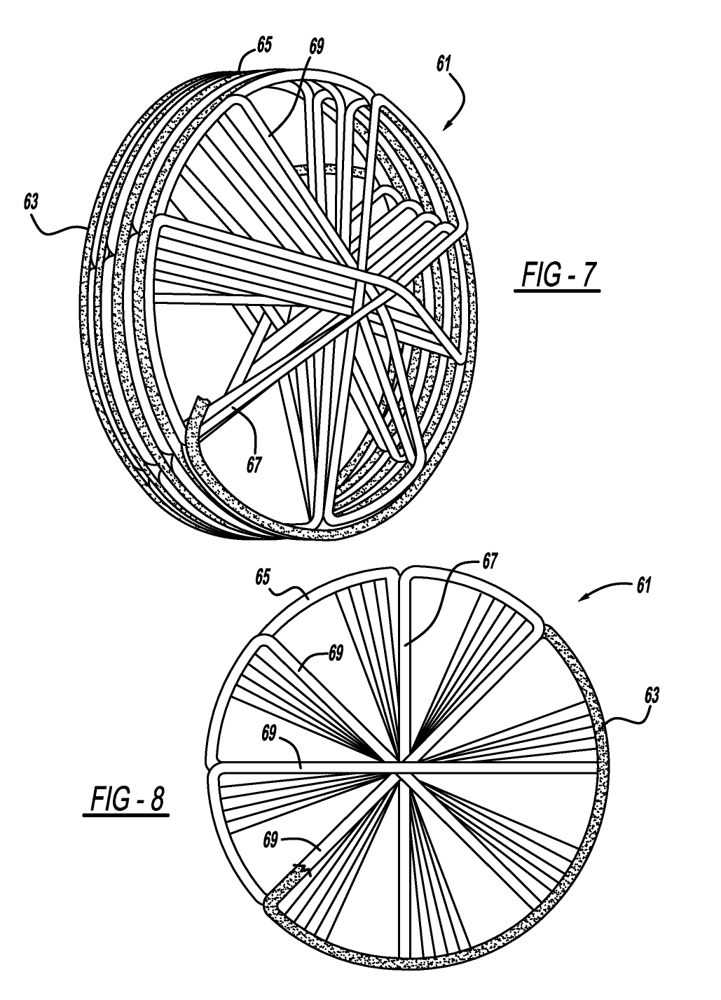

Referring to FIGS. 7 and 8, another embodiment woven impeller 61 includes a magnetic, electromagnetically energizable, or conductive fiber 63 woven into a shroud 65. Fiber 63 is an individual and separate member woven or placed in alternating layers to continuous, nonconductive fiber 67. Fiber 63 is preferably an elongated and continuous fiber which is resin coated. Fiber 67 is woven such that it creates blades 69 and peripheral shroud 65. Thus, fibers 67 and 63 integrally create blades 69 and shroud 65 as a single piece.

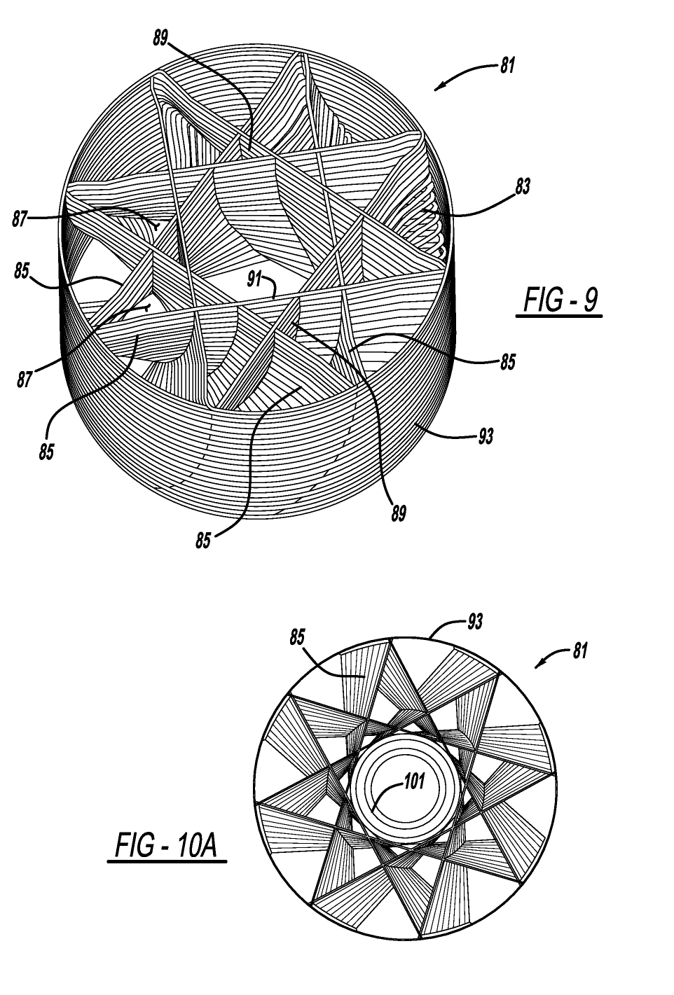

As shown in FIG. 9, another embodiment impeller or rotor 81 of the present invention includes one or more continuous nonconductive fibers 83 woven to define sixteen spaced apart and curved blades 85, flow-through passages 87 with flow dividers 89, a hub area 91 and a peripheral shroud 93 of circular-cylindrical shape. It is desired to tightly and closely stack the fiber segments upon each other with minimal space between in order to reduce fluid flow between the layered segments. Any remaining gaps are filled in by the resin coating from the fiber wetting process or other such post-processing. The pitch and curvature of each blade is set by slightly offsetting the angle or degree of rotation of each fiber layer segment relative to the previously placed layer segment from bottom to top. The FIG. 9 rotor configuration, when not filled with a solid hub or central bearing, is well suited for wind and water turbine use since birds and sealife can pass through the central opening. Also, the outer shroud creates an outer boundary recognized by birds to avoid blade impacts. Additionally, the outer shroud advantageously reduces noise and tip leakage (i.e., performance loss) of the blades, thereby enhancing performance and work extraction for the same area.

Furthermore, FIG. 13 illustrates a variation where a couple of transversely oriented sheets and/or fibers 95 and 97 are laterally wrapped around the stacked fibers 83 defining shroud 93. Each of these sheets 95 and 97 is a composite laminate material, such as resin impregnated polymeric cloth or the like which is flexibly applied on top of or circumferentially wrapped around the entire shroud between blades 85. It is also envisioned that these sheets can be secured to the underlying shroud fibers by a pressure sensitive adhesive. Alternately, these transverse wrappings may include at least one continuous fiber 83 which is the same as that that makes up the shroud and blades; this transverse wrapping may spiral around the circumferential fibers otherwise defining the shroud. This transverse wrapping and added sheets increase the shroud strength and stiffness which may be desirable for some uses.

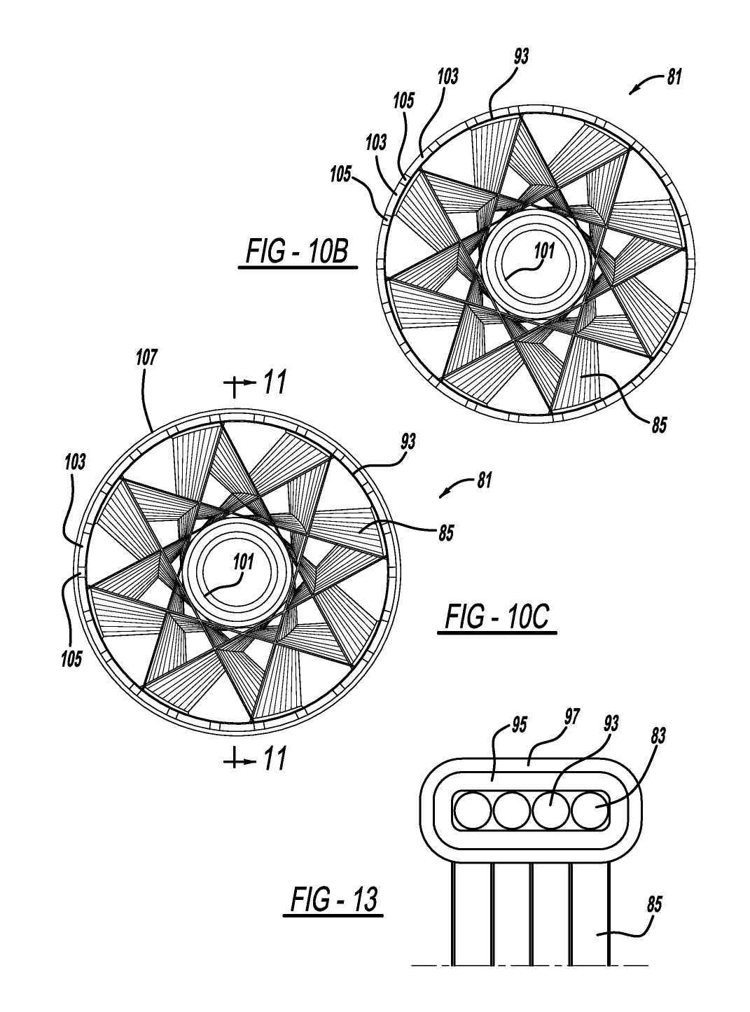

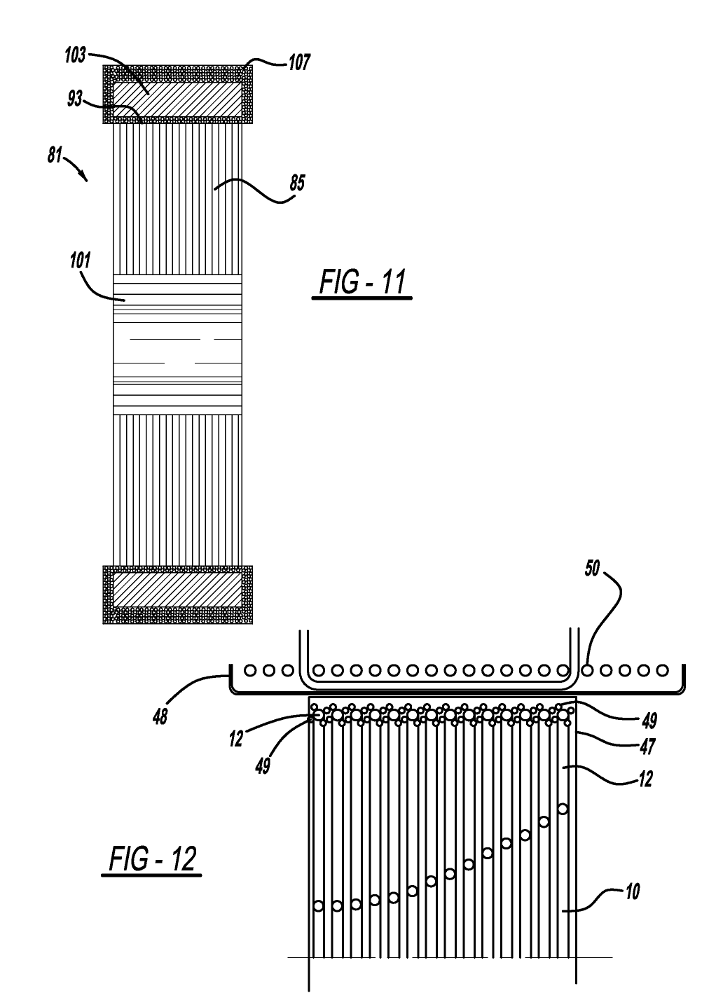

FIGS. 9, 10A-10C and 11 show another configuration of rotor 81 with discreet peripheral magnets, and the sequential steps to manufacture such a rotor. First, a resinated continuous fiber rotor 81 is woven and layered into the shape illustrated in FIG. 9. Secondly, referring to FIG. 10A, a metallic hub 101 is inserted within a center of rotor 81 and secured by adhesive bonding, although supplemental mechanical fasteners, such as rivets, screws, knurled projecting formations, and the like can be employed depending upon the rigidity of the cured rotor. Thirdly, FIG. 10B shows a plurality of discreet magnets 103 adhesively bonded to an outside periphery of shroud 93. Furthermore, insulating spacers 105 are adhesively bonded between adjacent pairs of magnets 103. Fourthly, an external composite laminated sheet 107, or additionally, transversely wound continuous fibers, surround magnets 103 and spacers 105 and also serve to secure them to shroud 93, as can be observed in FIGS. 10C and 11. An annular bearing, such as a ball bearing race assembly can be attached at bearing 101 to the hub of rotor 81. Such a bearing 101 is mounted to a pintle or pivot stationarily affixed within a housing, pipe, mast, tether, frame or other such mounting structure as will be described in further detail hereinafter. This rotor is ideally suited for use in any of the embodiments disclosed herein.

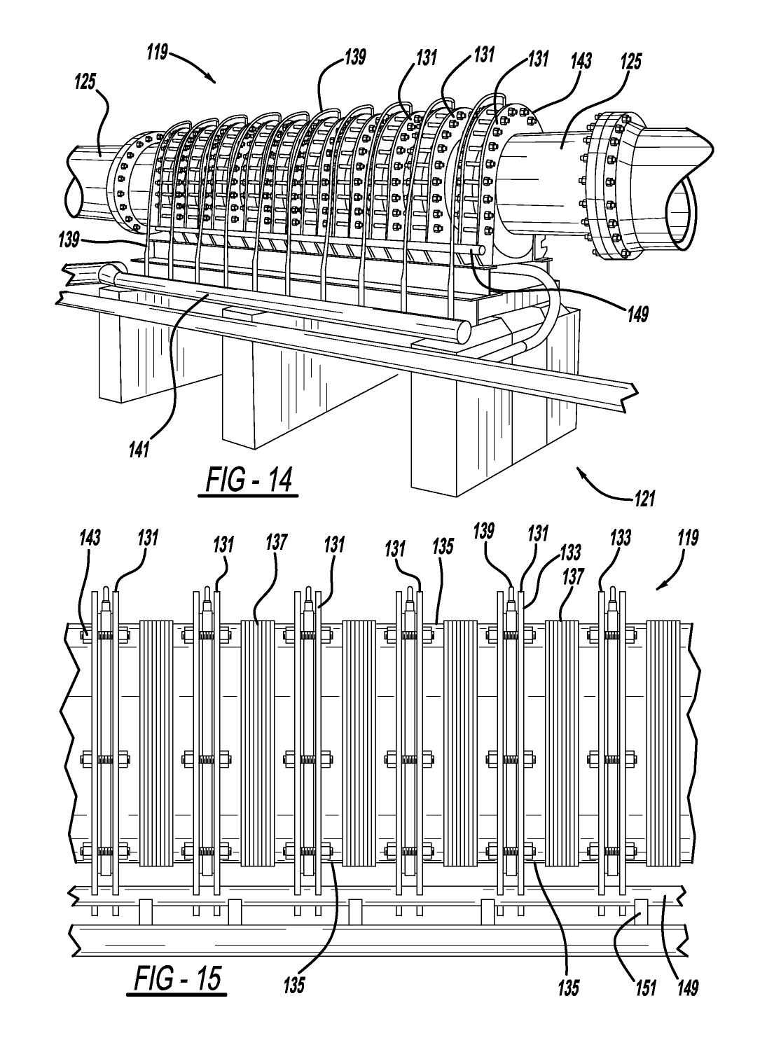

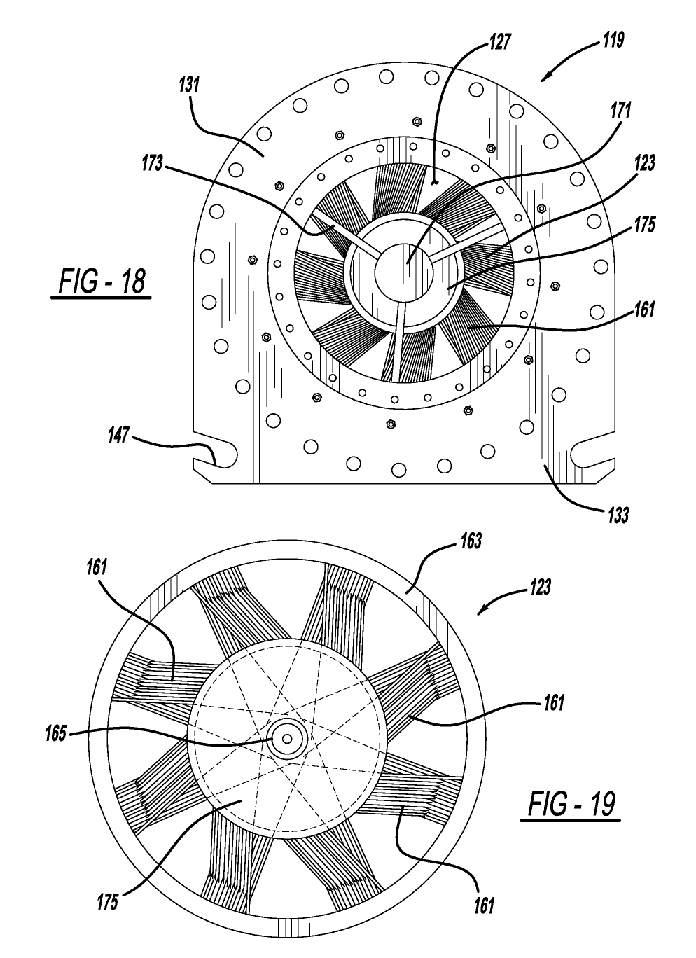

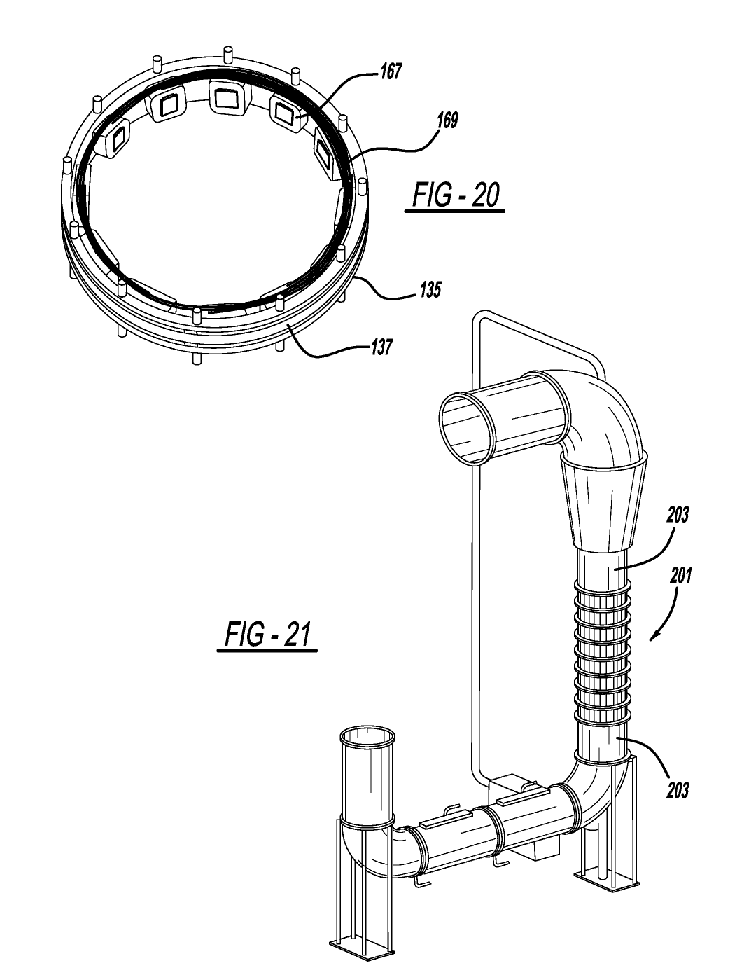

FIGS. 14-20 illustrate a rotor apparatus 119 of the present invention used in a geothermal fluid power plant, or alternately a natural gas plant, power plant, CO₂ ground injection, methane pipeline, ammonia pipeline, petroleum refinery or pipeline, sour or corrosive gas in a chemical plant, or other fluid refining factory 121. Multiple woven or stacked fiber rotors 123 (shown as wafer discs) are coaxially stacked in-line with one or more generally horizontally elongated pipes 125 to compress or otherwise move geothermal noncondensable gas fluid 127 flowing therethrough.

Rotor apparatus 119 is preferably constructed as modularized units where each self-contained module includes an external steel, injection molded polymer, or composite housing 131 made up of parallel planar plates 133 which sandwich a stator 135 therebetween. In this version, cooling conduits 137 or pipes surround stator 135 and are coupled to a valve and coolant supply line 139, connected to a main manifold 141. Manifold 141 is further connected to a coolant chiller and pumping device (not shown).

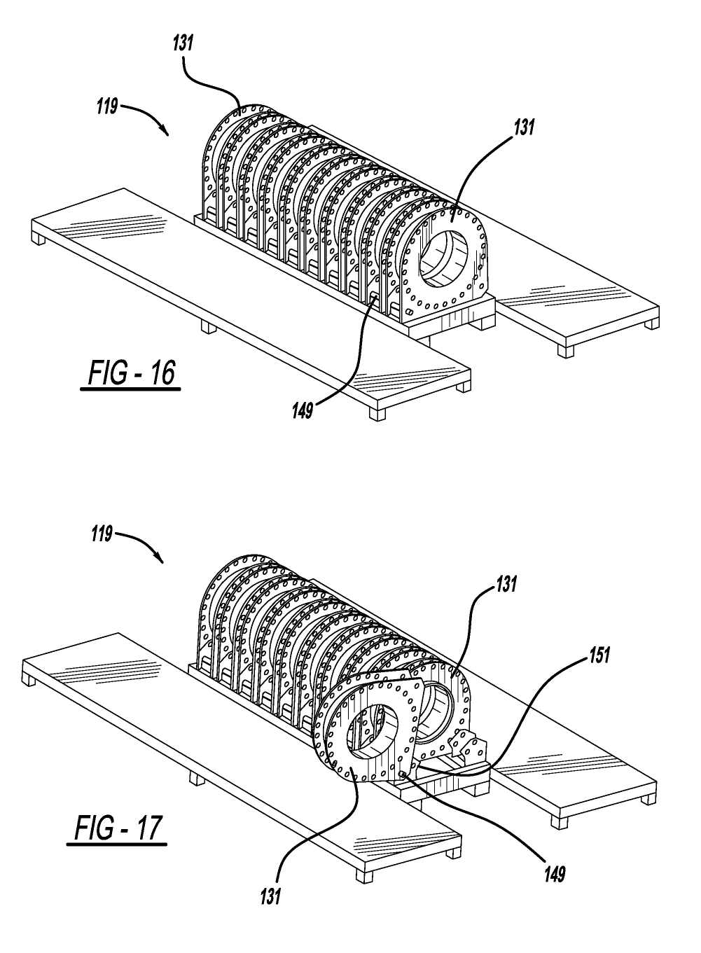

Removeable nut and bolt assemblies 143 couple plates 133 of adjacent modules or housings 131 to each other to secure the rotor apparatuses together in a coaxially aligned manner with pipes 125. Additionally, an open access receptacle 147, or alternately an enclosed hole, is located adjacent a bottom peripheral corner of each plate 133. Receptacle 147 receives a rod 149 which is mounted to a stationary bracket 151. This arrangement allows for each housing module to be laterally pivoted about rod 149 when unbolted from the adjacent housing module. This provides for easy installation, servicing and replacement of one or more modules without disturbing the remainder. Therefore, this modularization and pivoting action significantly reduce non-productive down time of the rotor apparatus and the associated factory, while also allowing for rotor and stator access using significantly reduced module movement forces. This pivoting and modularized arrangement can best be observed by comparing the leading housing module 131 between FIGS. 16 and 17.

Rotor 123 is made from a continuous resinated fiber woven and stacked to have a generally star-shaped layered pattern for blades 161 and an integral shroud 163. A hub 165 is also present in the center of rotor 123. Rotor 123 can either be centrally driven by a motor-powered hub 165 or is preferably supplied with attached discreet magnets (see FIG. 10C), magnetic particles (see FIG. 12) or magnetic fibers (see FIGS. 5 and 7) for use with surrounding stator 135. Stator 135 includes magnetic windings 167 which are electrically connected to a wire harness 169 for supplying electricity thereto from a power source (not shown). When energized, stator 135 supplies electromagnetism which acts to spin the magnets attached to shroud 163 of rotor 123. Accordingly, blades 161 of rotor 123 contact against and compress the fluid flowing therethrough. Each adjacent rotor preferably spins in an opposite direction in order to maximize the energy and fluid flow efficiencies caused by this alternating clockwise, counterclockwise, clockwise, counterclockwise fluid rotation.

Rotor 123 can optionally include an integrated axial and radial magnetic bearing. Moreover, carbon fibers are preferred since they are easier to impregnate with a polymeric resin as compared to some other fiber materials and they exhibit improved centrifugal tensile strength during rhigh speed rotation as compared to many other materials. Optionally, each fiber, as the term is used herein, can include multiple twisted or otherwise bundled filaments. For example, a cross-section of each continuous fiber may optionally include more than 10,000 filaments. When woven, one exemplary configuration employs three fibers woven at the same time to constitute the entire rotor. Thus, each of the multiple fibers defines at least one entire blade and shroud layer or pattern which crosses itself in many locations, and each continuous fiber defines at least a pair of blades and the portion of shroud spanning therebetween.

It is noteworthy that each rotor has an independent hub 165 coupled to a central pintle or pivot projecting from a central structure 171. Three or more arms 173 span between central structure 171 and plates 133 in a stationary manner. A disc 175 is attached to and rotates with hub 165 in an optional arrangement of rotor 123 depending upon the fluid flow characteristics and structural support required for rotor 123. The independent hub and driving configuration for each rotor module 131 advantageously allows for the alternating clockwise and counterclockwise rotation of adjacent rotors 123. While the rotor is preferably of the continuous fiber and stacked construction, it is alternately envisioned that the modularized and clockwise, counterclockwise structure and functions can be applied to metal, composite and other types of non-fibrous rotors and impellers, although many of the lightweight and manufacturing advantages of the preferred version may not be achieved.

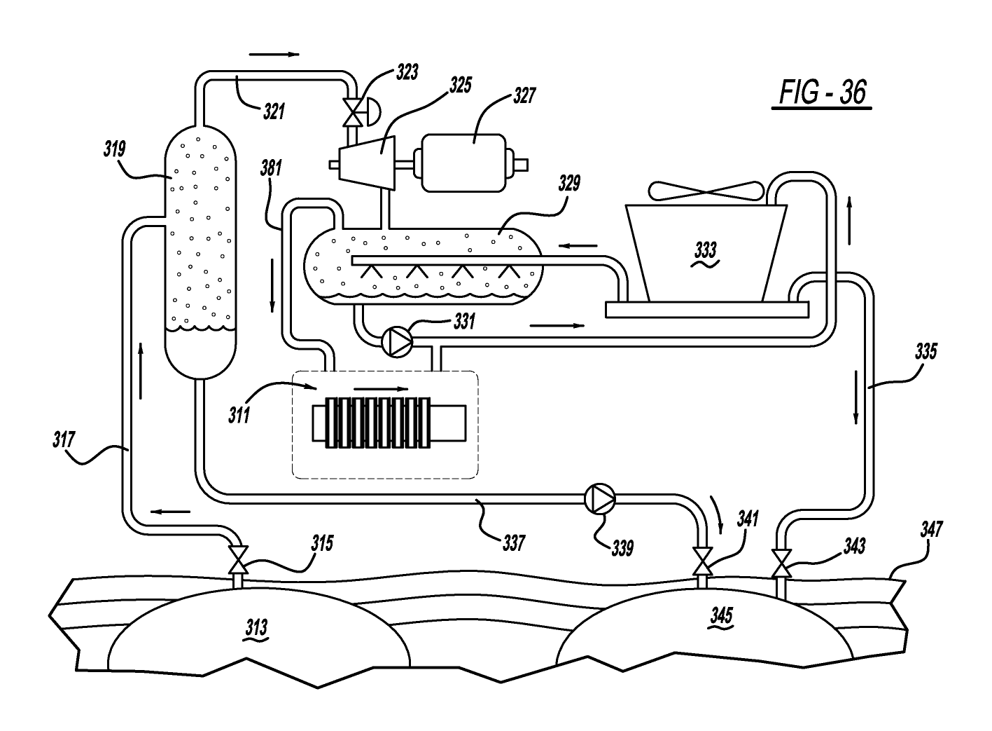

FIGS. 36-39 further pertain to the geothermal embodiment employing a rotor apparatus 311. The geothermal power plant is preferably of a single-flash design having a production well of hot geothermal fluid 313, a well head valve 315, an inlet pipe 317, a cyclone separator flash tank 319, a steam transmission pipe 321, a separator valve 323, a steam turbine 325 and a coupled electrical generator 327. Furthermore, the plant includes a heat exchanger or condensor 329, various expansion valves, a cooling water pump 331, and a cooling tower 333. A blowdown pipe 335, brine injection pipe 337, injection pump 339, and valves 341 and 343 carry waste fluid into a cooled geothermal fluid well 345 below a ground surface 347.

Rotor apparatus 311 receives and compresses non-condensable gases therethrough, acting as a turbo compressor but without a separate motor and gear box. As compared to traditional steam ejecter pumps having approximately 10-15% efficiency consistency, the present rotor apparatus compresses the NCG for removal with at least 50%, and more preferably 70% efficiency, thereby significantly reducing cooling water requirements and increasing electricity production. It is alternately envisioned that turbine 325 can employ a continuous fiber, resinated and woven rotor such as any of the embodiments herein. Moreover, it is noteworthy that all of the active conductive wire coils of the stator are located outside of the fluid stream thereby reducing conventional sealing requirements and minimizing fluid flow obstruction. Furthermore, rotor apparatus 311 creates a fluid pressure of 0.1-6.0 psia (and possibly more if no subsequent ring pumps or such are employed), and more preferably 1-4 psia, depending on the plant requirements.

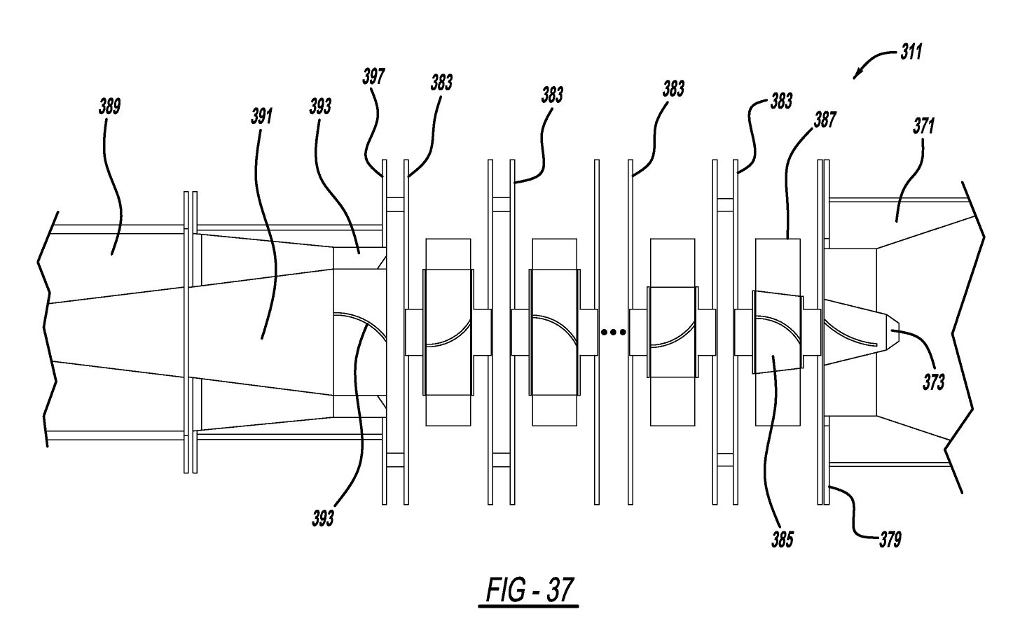

FIGS. 37-39 illustrate the details of rotor apparatus 311 employed for NCG compression, without the conventional need for parasitic steam use. An inlet structure 371 includes a closed nose cone 373 centrally positioned within outwardly radiating guide vanes 375 surrounded by a circular tapered collar 377. Inlet structure 371 is stationarily mounted to a base rail and flange 379. Inlet pipe 381 (see FIG. 36) is in direct communication with inlet structure 371 for supplying NCG fluid thereto. Each module 383 of rotor apparatus 311 includes a continuous, resinated fiber rotor 385 and stator 387 as discussed with any of the embodiments herein. At least two, more preferably at least four and most preferably at least ten wafers or modules 383 of rotor 385 are provided in a single geothermal power plant for compressing NCG fluid. The first module rotates in a first direction, the adjacent second module rotor rotates in an opposite second direction, the adjacent third module rotor rotates in the first direction, the adjacent fourth module rotor rotates in the second direction, and so forth in an alternating manner to maximize fluid flow efficiencies. Thereafter, an outlet structure 389 includes a frusto-conical tail cone 391 and outlet guide vanes 393 within a circular collar 395 which is stationarily mounted to a base rail and housing 397. Inlet and outlet structures 371 and 389, respectively, are preferably made from stainless steel sheet metal or composite materials. Alternately, however, an electric motor and coupled drive shaft can rotatably drive each central hub of each rotor 385, although many of the weight, space, cost and sealing savings may not be achieved as compared to the preferred integrated, brushless and concentrically peripheral rotor and stator design. Also, a motor/generator and/or magnetic bearings can be integrated in the tub.

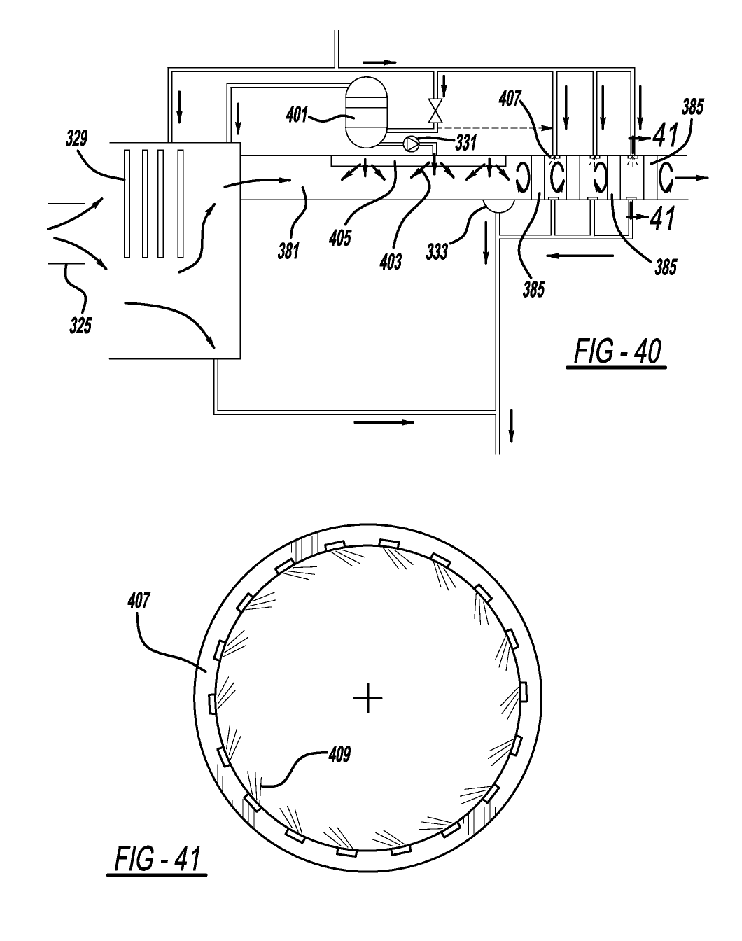

A cooling system is illustrated in FIGS. 40 and 41. Fluid flows from condenser 329 and from a water vapor compressor/chiller 401, including an evaporator. Cooling water 403 is sprayed from nozzle aperatures 405 in a manifold position along inlet pipe 381. Additionally, a ring-shaped coolant conduit 407 is mounted coaxially adjacent each stator for each rotor module. Coolant water fluid 409 is inwardly sprayed from conduit 407 so as to cool various rotating components, such as central hub bearings of each rotor 385. The compressed fluid can also serve as intercooling for the bearings.

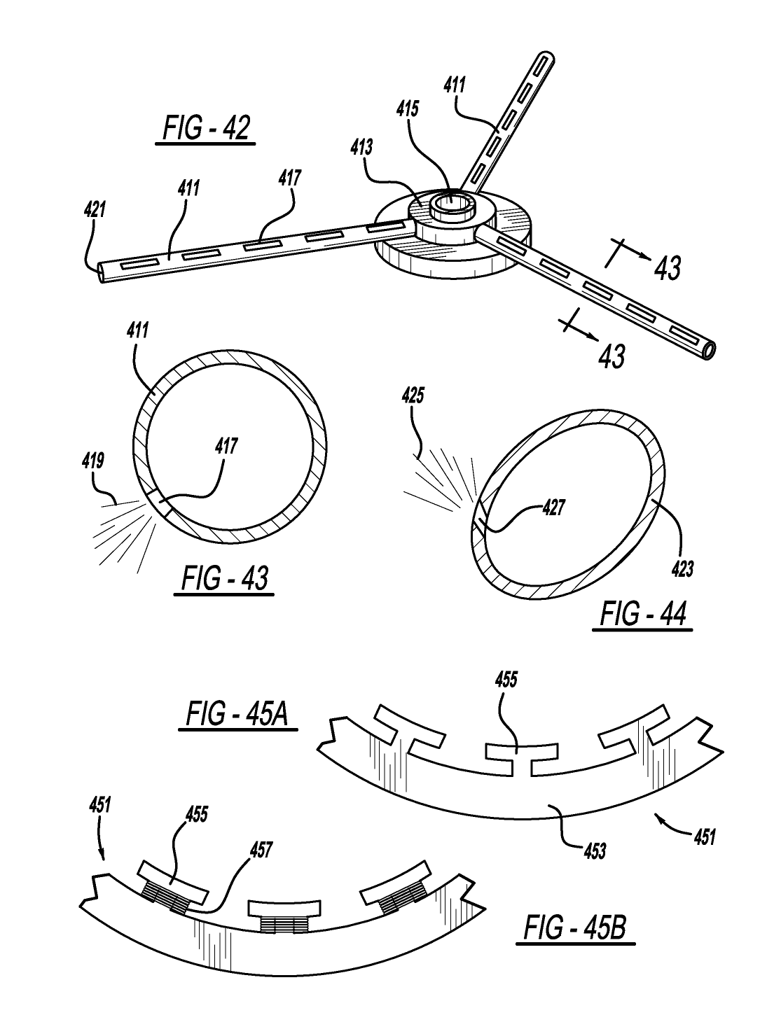

Another embodiment cooling system is illustrated in FIGS. 42 and 43. In this variation, structural arms 411 outwardly radiate from a central structure 413, preferably having a circular shape, but the arms also may benefit from an aerodynamically shaped profile like a tear drop or wing profile. A pintle or pivot 415 may axially extend from central structure 413 upon which the rotor rotates with bearings therebetween, or the center of central structure 413 can alternately be an open and unobstructed aperature in fluid communication with arms 411. Elongated and slotted aperatures 417 are provided along each arm 411 to act as nozzles in emitting coolant fluid 419 therefrom. Coolant fluid 419 is emitted toward a corresponding rotor so as to cool its hub bearings or other frictional surfaces. Coolant fluid 419 may also be sprayed toward insulated portions of the stator for cooling it as well. The coolant fluid is pumped into at least one distal end 421 of arms 411. Each arm 411 preferably has a circular and hollow cross-section for improved structural rigidity and also to impart less turbulence on the coolant fluid flowing therein. Alternately, however, each cooling arm 423, as shown in FIG. 44, can have an oval or polygonal cross-sectional shape to spray coolant fluid 425 in an offset angled manner from its aperatures 427. The cooling fluid is preferably filtered and condensed geothermal water with an ambient pressure of at least 80 psi, as it exits the nozzles. The coolant water also beneficially acts on the less dense steam under a partial vacuum to redirect the steam flowing between the rotors. Such a cooling system can also be used with the natural gas compressor embodiment, whereafter due to the higher pressures, the water will condense out and be collected after cooling the components. Alternately, the coolant can be ducted through the arms without spray aperatures.

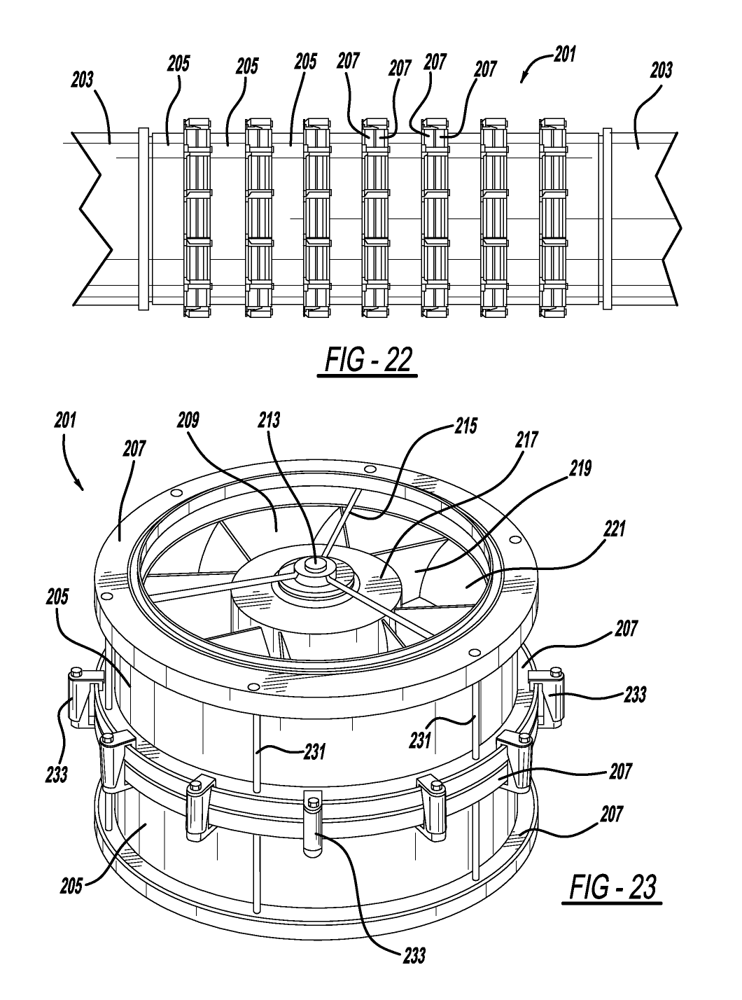

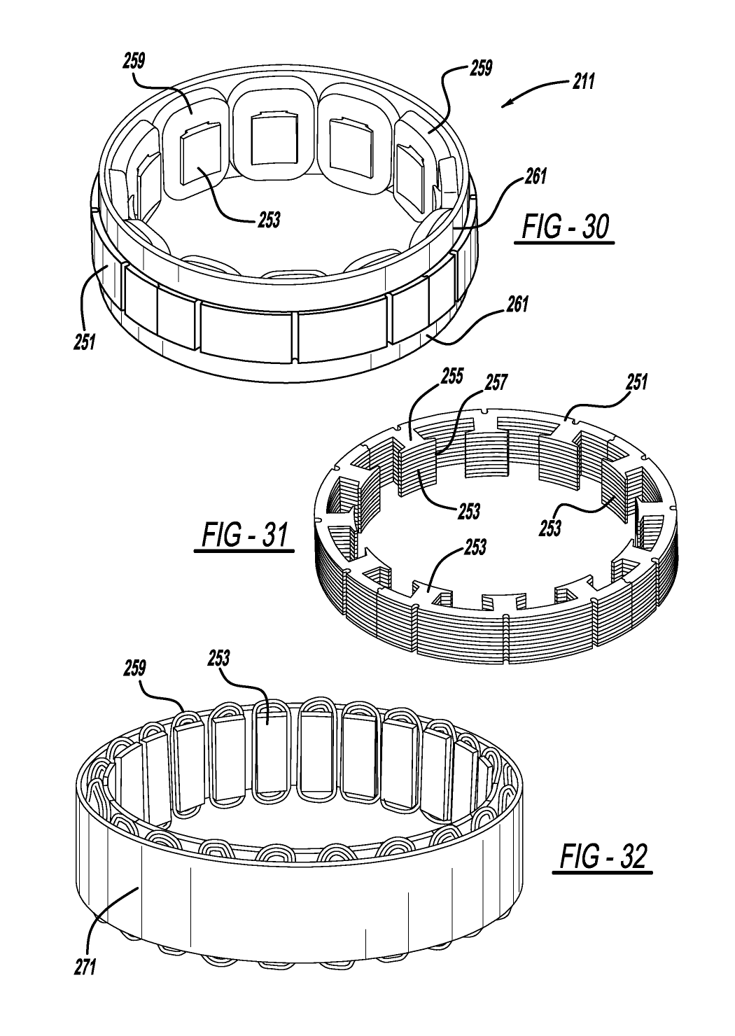

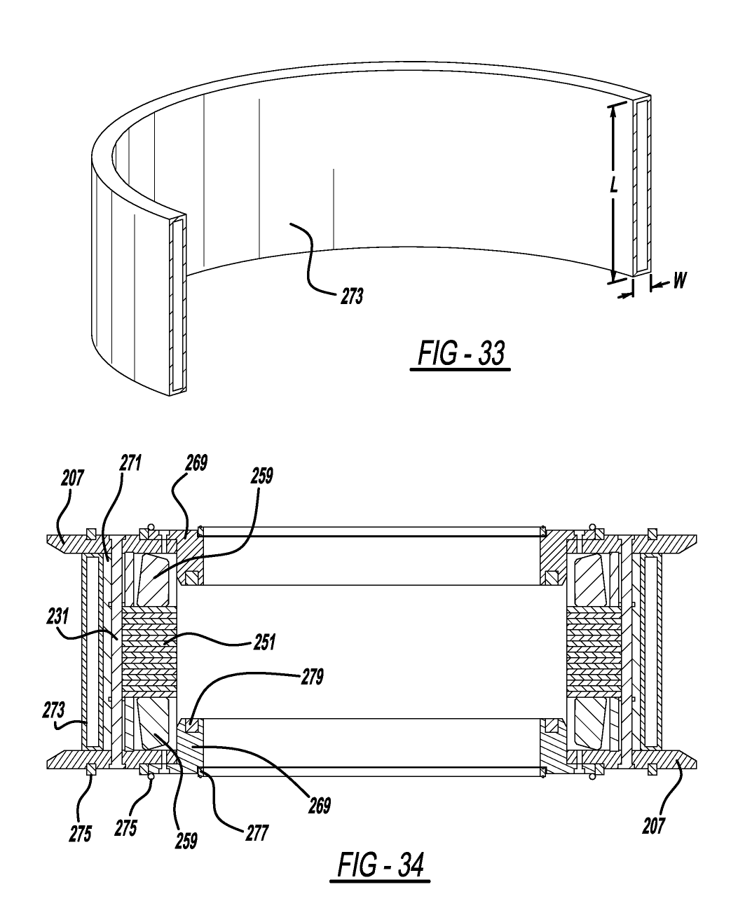

Another configuration of a rotor apparatus 201 used in a generally vertically aligned natural gas pipeline 203 can be observed in FIGS. 21-34. “Natural gas” is used herein to include it in both gaseous and liquid forms. It should also be appreciated that this configuration is also useable with geothermal, CO₂, ammonia, methane, sour gas, and petroluem fluid compression.

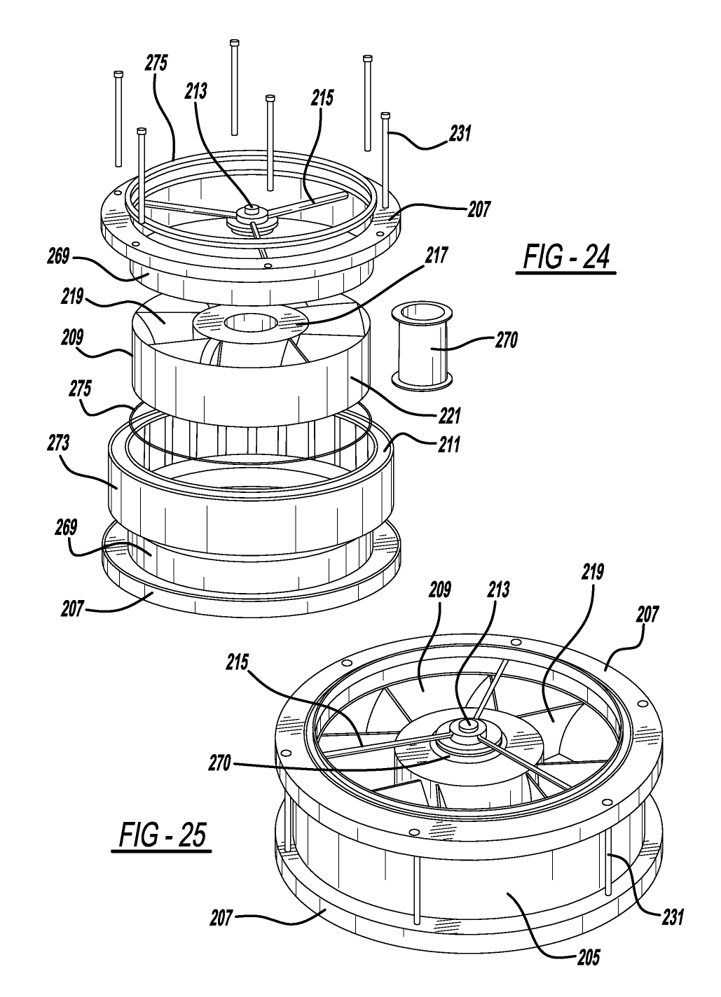

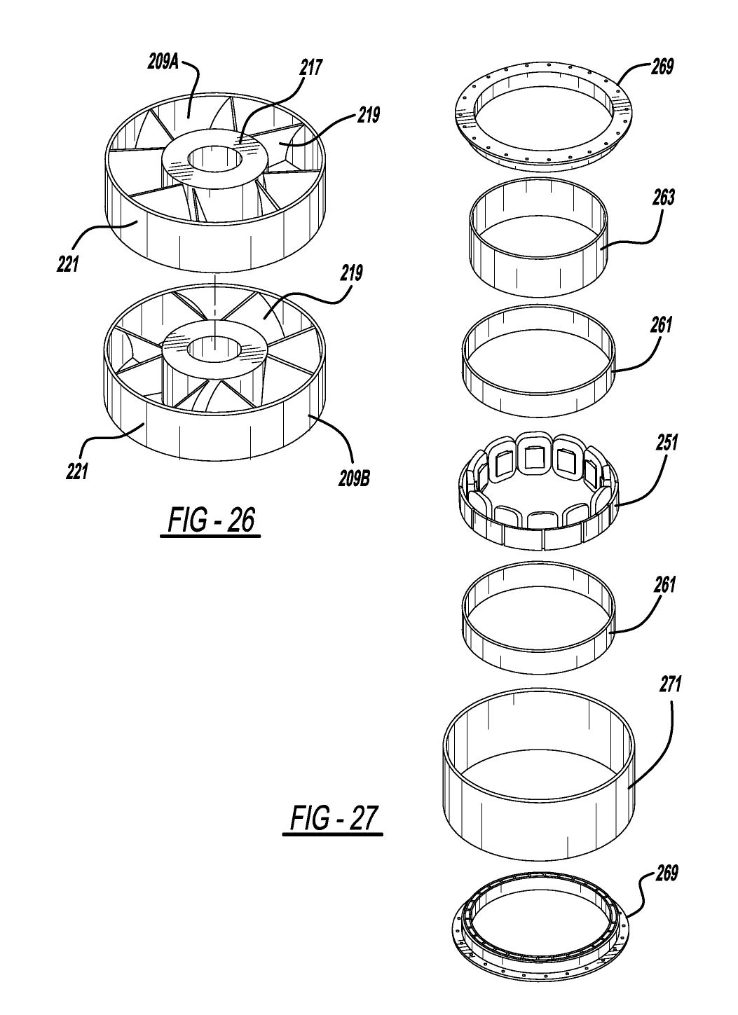

In this embodiment, multiple coaxially aligned modules 205, also known as wafers, each include circular outer housings 207 which sandwich a rotor 209 and a concentrically surrounding stator 211. A pintle or pivot 213 is supported by three or more support arms 215 which are stationarily affixed to housing 207 and support a hub 217 of the corresponding rotor 209. A bearing spool 270 (see FIG. 24) is located between pivot 213 and hub 217. Each rotor 209 further includes multiple blades 219 and an intregral shroud 221, both woven from at least one continuous resinated fiber as provided with any of the other embodiments discussed herein. Rotor 209A has its blades 219 angled such that its clockwise rotation (as illustrated in FIG. 26) is opposite to the blade angle of rotor 209B, adjacent thereto, which causes fluid flow rotation in a counterclockwise direction. Thus, each adjacent rotor module 205 has an opposite rotational direction.

Longitudinally elongated bolts 231 secured together the flanges of housing 207 spanning across the outside of the stator for each module. Nuts may not be required since one of the housing flanges may have threaded holes for enmeshing with the threads of bolts 231 while the opposite end of each bolt has a polygonal peripheral shape to its head which corresponds with a matching polygonal hole in that flange of housing 207. Furthermore, double jaw clamps 233 couple together adjacent pairs of modules 205, in an easily moveable manner to allow for single module service and replacement. Alternately, a chain slung around the flanges and fastened can be used to hold the flanges together. The chain can be metallic, composite or both.

Stator 211 includes stacked laminated layers of magnetically conductive metallic rings 251. High magnetic permeability is desired, and the thin lamination is to prevent electric eddy currents. So the best possible low transverse electrical conductivity and in-plane high magnetic permeability is the goal for the laminations in general. The ring stack include a set of inwardly projecting teeth 253. Each tooth has a radially oriented stem 255 and a laterally enlarged crown 257, defining a generally T-shape. Electrically conductive wire coils or windings 259 are wrapped around stem 255 of each tooth 253. Moreover, a pair of annular support rings 261 sandwich the electrically conductive ring stack 251. Support rings 261 serve to hold together the ring stack while also conducting away heat from the wire windings 259. Support rings 261 are preferably made from stainless steel. The rings 261 are also known as spacer elements and can include studs, bushings or tubes.

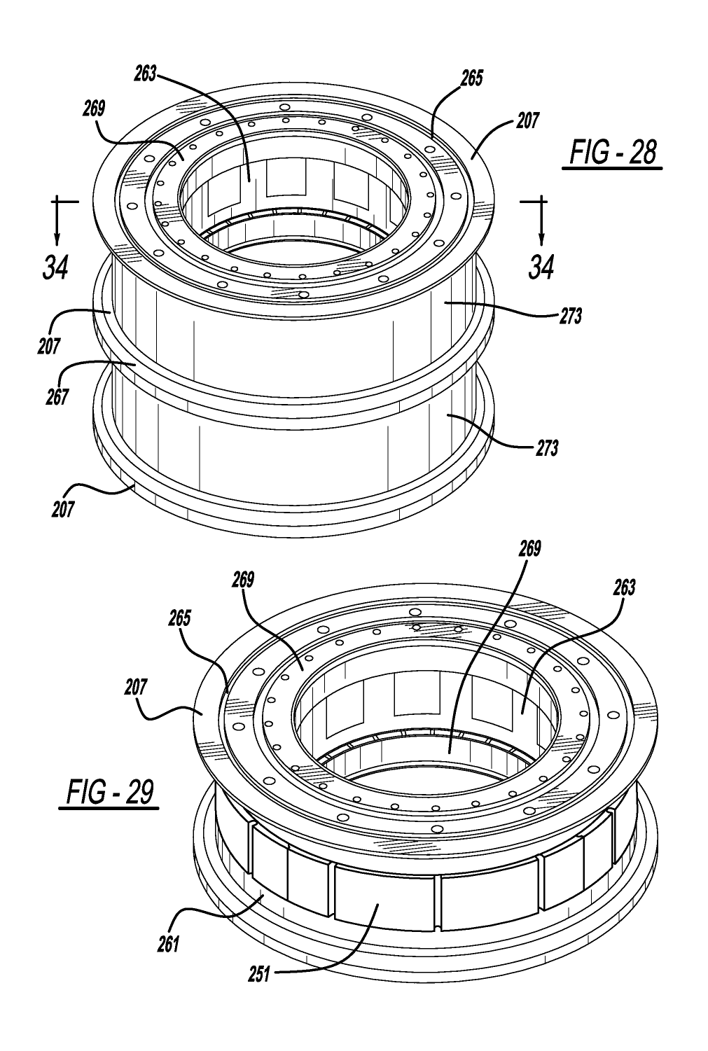

Furthermore, a thin polymeric film defines a circular vapor barrier 263 (see FIGS. 27 and 29) which is internally located against crown 257 of teeth 253 to serve as a barrier to protect stator 211 from the natural gas (or alternately, geothermal “sour” fluid) passing through the rotor apparatus. A prefabricated carbon composite tube is used as inner liner or barrier 263 (which provides vapor barrier and mechanical protection). Eventually, this may be plastic as part of an injection molding process. Moreover, each or housing flange 207 includes an alignment groove 265 and a peripheral chamfer 267 (see FIG. 28) to assist with mating of clamps 233 or alternately, a circular chain clamp. An axial bearing mount 269 has an annular shape and is bolted to the adjacent housing flange 207. Axial bearing mount 269 centers and fixes a stationary part of an axial magnetic bearing system to the rotor apparatus. Each bearing mount 269 is easily removable by detaching the threaded bolt fasteners, thereby allowing quick and direct access to the inside of stator 211 and the internal rotor 209 for quick maintenance and/or replacement.

An outer steel support ring 271 surrounds an outside periphery of conductive ring stack 251, which supplies the main supporting structure within each module or wafer. Outer support ring 271 also conducts heat away from conductive ring stack 251. A hollow and either circular or two-part semi-circular water jacket 273 concentrically surrounds outer support ring 271. Coolant water or other fluid is pumped through the internal cavity of water jacket 273 for removing heat from the stator during energization. Water jacket 273 is preferably at least four times longer in its longitudinal direction L as compared to its considerably thinner width direction W, and defines a single open fluid flow cavity for the entire stator module, rather than individually wrapped pipes which exhibit differing internal coolant pressures, temperature gradients and fluid volume characteristics. Sealing and centering O-rings 275 are also employed. A flash intercooling injection ring 277 is additionally provided which can also be used for massive spray in actually condensing condensable parts of the fluid stream (like water vapor) and reducing required compressional power if water vapor can be reduced by condensation. Furthermore, axial bearings 279 are secured to axial bearing mounts 269. This rotor and stator assembly are ideally suited for compressing natural gas, but are also suitable for use in any of the other embodiments disclosed herein.

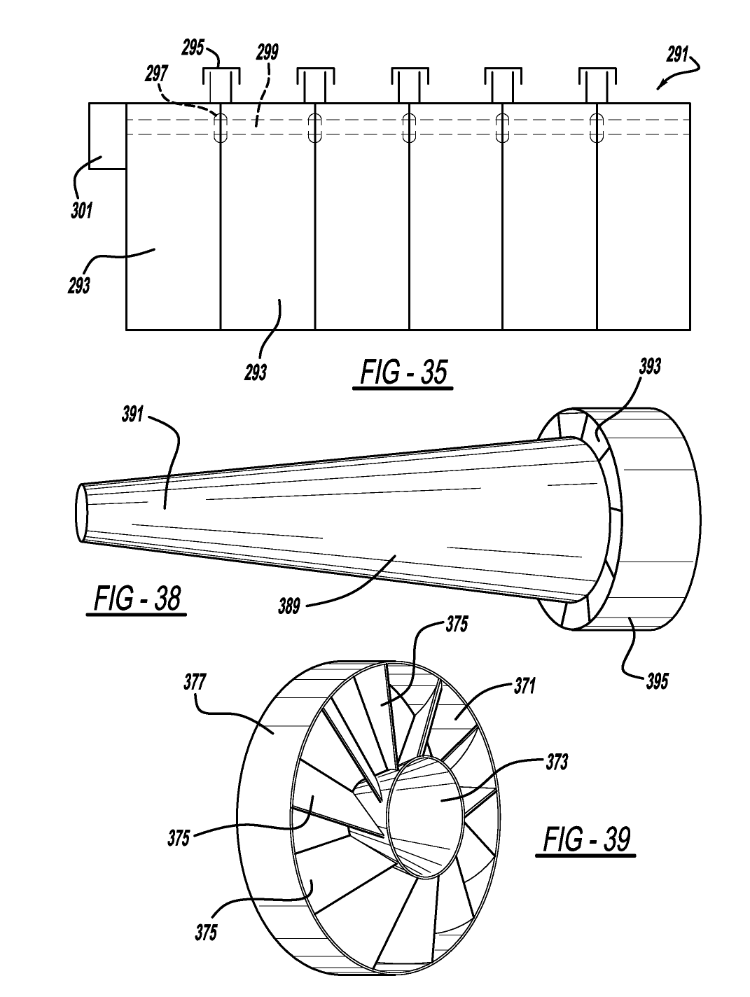

FIG. 35 illustrates another embodiment of a rotor apparatus 291 employed in any of the uses discussed herein. In this embodiment, multiple rotor and stator modules 293 are coaxially aligned like that of the prior embodiments with clamps 295 or threaded fasteners removeably securing together housing flanges extending from adjacent modules 293. Elastomeric O-shaped sealing rings 297 are provided for each mating surface of modules 293 to couple together coolant conduits 299 extending through a housing of each stator therein, however, other sealing methods including the application of bulk sealant, are possible. A coolant manifold 301 is coupled to one or both ends of the coolant conduits 299. Such modularized approaches with this and the prior embodiments, is enhanced when used with the lightweight continuous fiber rotor as previously discussed hereinabove.

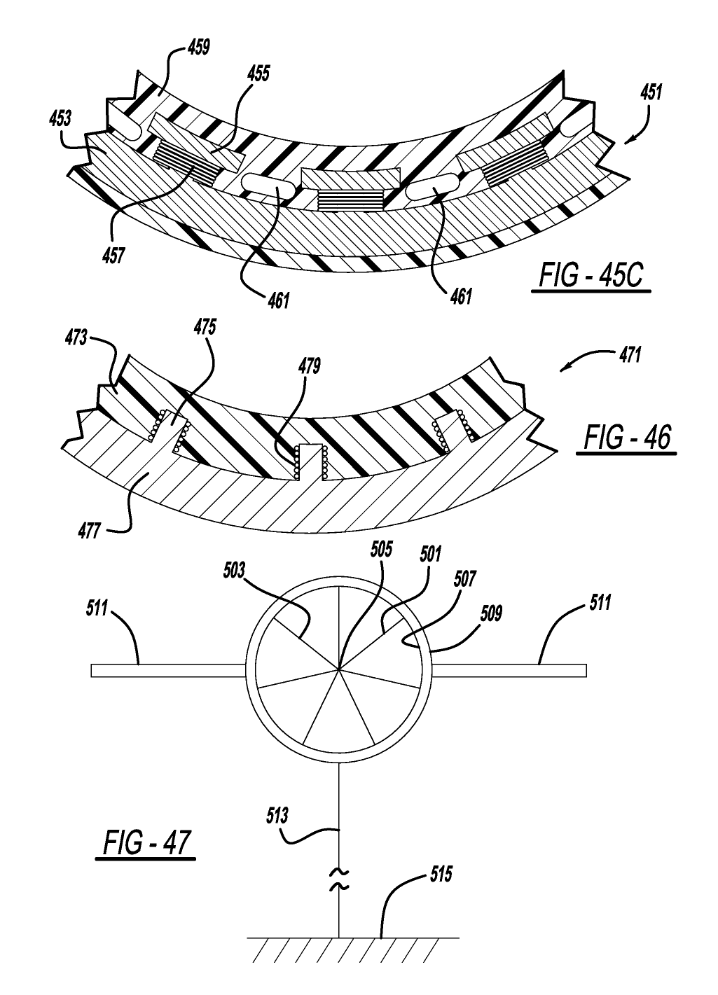

Another configuation of a stator 451 is shown in FIGS. 45A-45C. As can be viewed in FIG. 45A, a generally annularly shaped and magnetically conductive stack 453 is stamped or laser cut from metallic sheets to have an annular shape with internally projecting T-shaped teeth 455. Thereafter, electrically conductive copper wires 457 are wound around the radial shaft of each tooth 455, as illustrated in FIG. 45B. Subsequently as shown in FIG. 45C, a high temperature, engineering grade polymeric material 459 is insert injection molded, or alternately dip coated or otherwise formed, to entirely encapsulate conductive stack 453 and wire windings 457. Moreover, through use of gas assist in the injection molding machine and molds, or alternately using lost wax casting or the like, elongated cooling conduits 461 are located within polymeric material 459 between each adjacent pair of teeth 455. In otherwords, conduits 461 are essentially predetermined, hollow voids within the insulating polymeric material 459. Conduits 461 are coupled to a manifold or other coolant fluid supply for cooling stator 451. Also, electrical communication connectors for the motor power supply and controls may be incorporated in such processes as to that the wafers get connected automatically on a common rail/bus when joined together.

A different embodiment stator 471 of the rotor apparatus can be observed in FIG. 46. A polymeric material 473 encapsulates radial teeth 475 inwardly extending from the annular magnetically conductive stack 477. Only a shaft, without a laterally enlarged head or crown, is employed with this embodiment. Wires 479 are wrapped around each tooth 475. Cooling conduits may be integrally provided within polymeric material 473 between each pair of teeth 475 as an option for this embodiment as well. The polymeric material 459 of FIG. 45C and 473 of FIG. 46 is ideally suited for use as part of a rotor apparatus for a turbine generator or NCG compressor in a geothermal plant since electrically conductive components will be protected from the hydrogen sulfide and other corrosive chemicals typically present in sour geothermal fluid. This arrangement is also well suited for use in seawater, for water turbines, or for water purification applications. These exemplary polymeric protection layers on the stator are preferably used with the continuous fiber rotor (which also resists corrosion), but can alternately be employed with a conventional metallic rotor although many of the benefits will not be obtained.

FIGS. 47-54 illustrate various wind (i.e., airflow) turbine constructions employing a continuous, resinated and stacked or woven fiber for a rotor as disclosed with any of the embodiments discussed herein. For example, FIG. 47 shows a fiber rotor 501 having multiple blades 503 spanning between a central hub 505 and a peripheral integrated shroud 507. Shroud 507 is mounted within a stationary housing 509 which includes outwardly extending wings 511 to provide aerodynamic lift and/or positional orientation in the air. Wings 511 can have airfoil cross-sectional shape such that the lift overcomes drag forces otherwise tending to lower the housing in high flow speed situations. A flexible tether 513 secures housing 509 to ground 515. This embodiment can also be employed as a water turbine.

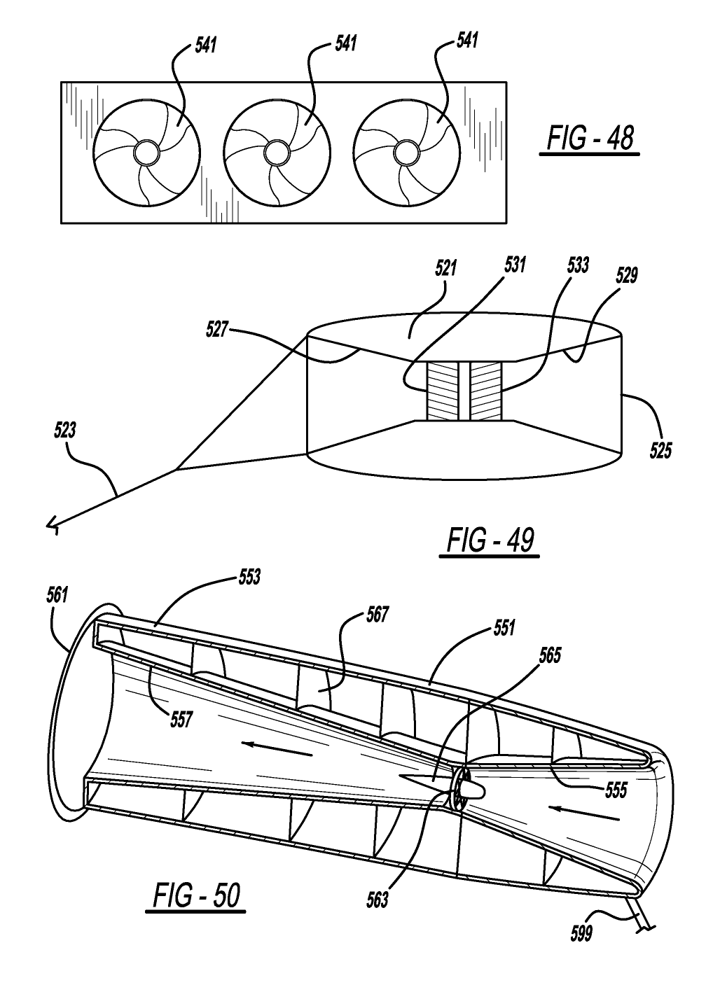

FIG. 49 shows a self-buoyant aircraft 521, such as a balloon or zepplin, which is floating in the air and anchored to the ground by tether 523. A housing 525 includes tapered inlet and outlet channels 527 and 529, respectively, within which are mounted woven rotor wheels 531 and 533 in the center thereof. Rotors 531 and 533 preferably have integrated generators and may either be a single stage or more preferably, counter-rotating pairs. The counter-rotation of the rotors minimizes torque to the entire housing thereby providing constant desired orientation and stability in the air. It should also be appreciated that one, two, three or more rotors may be used within housing 525. This aircraft 521 is capable of remaining in the air even if there is no wind present. This embodiment can also be employed as a water turbine. A side-by-side arrangement of counter-rotating rotors 541, such as show in FIG. 48, may alternately be provided within housing 525 of FIG. 49.

Another embodiment aircraft 551 is shown in FIG. 50. Aircraft 551 is preferably a self-bouyant balloon including an outer housing 553, and internal inlet and outlet channels 555 and 557, respectively, of frusto-conical tapered design. Additionally, a flexible tether 599 anchors a nose of aircraft 551 to the ground while a drag ring 561 is provided at a tail end of aircraft 551 to maintain the desired orientation of the inlet channel relative to the prevailing wind. One or more continuous stacked fiber rotors 563 are located within a neck of housing 553. An internal generator 565, driven by a hub of rotor 563 is internally provided therein so as to create electrical current which is transmitted down a wire inside of tether 599. Alternately, a peripherally mounted and integrated generator can be provided. Dividers or joists 567 are positioned between outer housing 553 and channels 555 and 557, in order to provide structural stability to the aircraft. The diameter of rotor 563 is between 20 cm-1.5 m, and more preferably between 0.5 m-1 m. This embodiment is also suitable for use as a tidal or water current turbine where the rotors may also be larger.

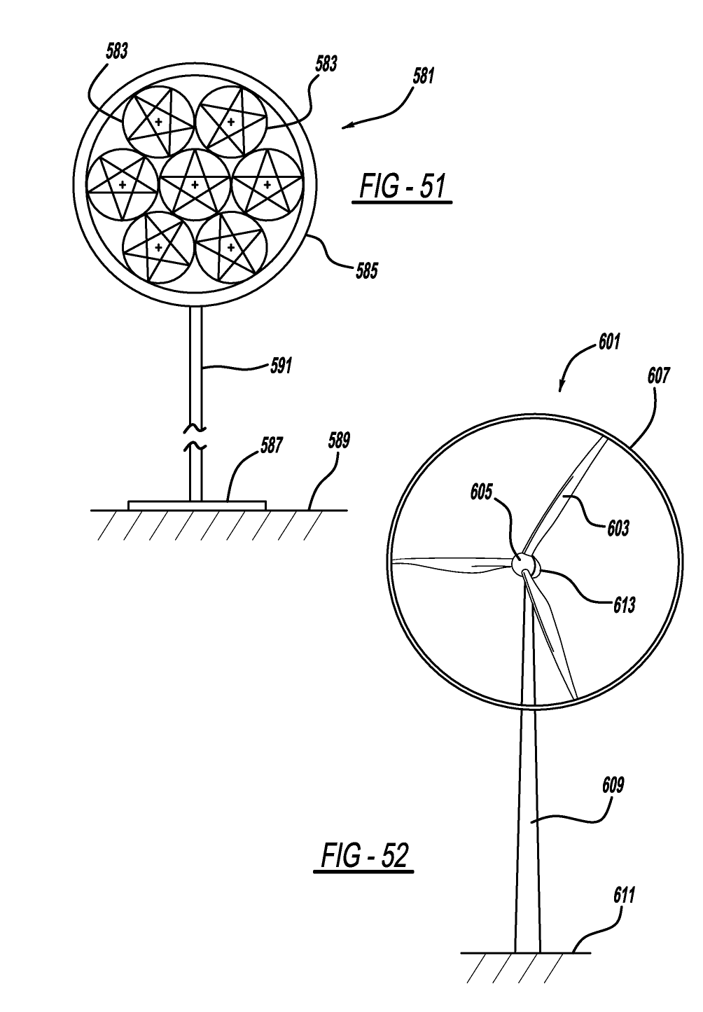

Yet another version of rotor apparatus 581 is provided in FIG. 51. At least two, and more preferably eight woven rotors 583 are clustered within an outer and stationary housing 585. Each rotor 583 includes magnetic material (for example, ferrite powder) which rotates within conductive wire windings of a stator to generate electricity. Housing 585 is anchored to a base 587, on the ground 589 by way of a stationary and rigid mast or tether 591. This embodiment is useful for both wind turbine and water turbine power generation or fans.

Another rotor apparatus 601 for use as a wind turbine can be viewed in FIG. 52. This embodiment employs airfoil shaped blades 603 radially spanning between a central hub 605 and a circular shroud 607. Blades 603, hub 605 and shroud 607 are preferably made from a continuous, resinated and woven fiber arrangement as discussed with any of the embodiments herein. A rigid and stationary mast 609, mounted to the ground 611, supports a generally horizontally elongated and rotating armature upon which hub 605 is mounted. A hub-driven generator 613 produces electricity in response to the wind airflow contacting against and rotating blades 603, and in turn, the armature. Shroud 607 advantageously discourages birds from entering the internal space therein, thus, protecting the birds from harm by blades 603. Also, the outer shroud may increase performance as the tip leakage is minimized. The light-weight nature of the resinated fiber rotor is highly advantageous for shipping, insulation and power generating efficiencies in this use.

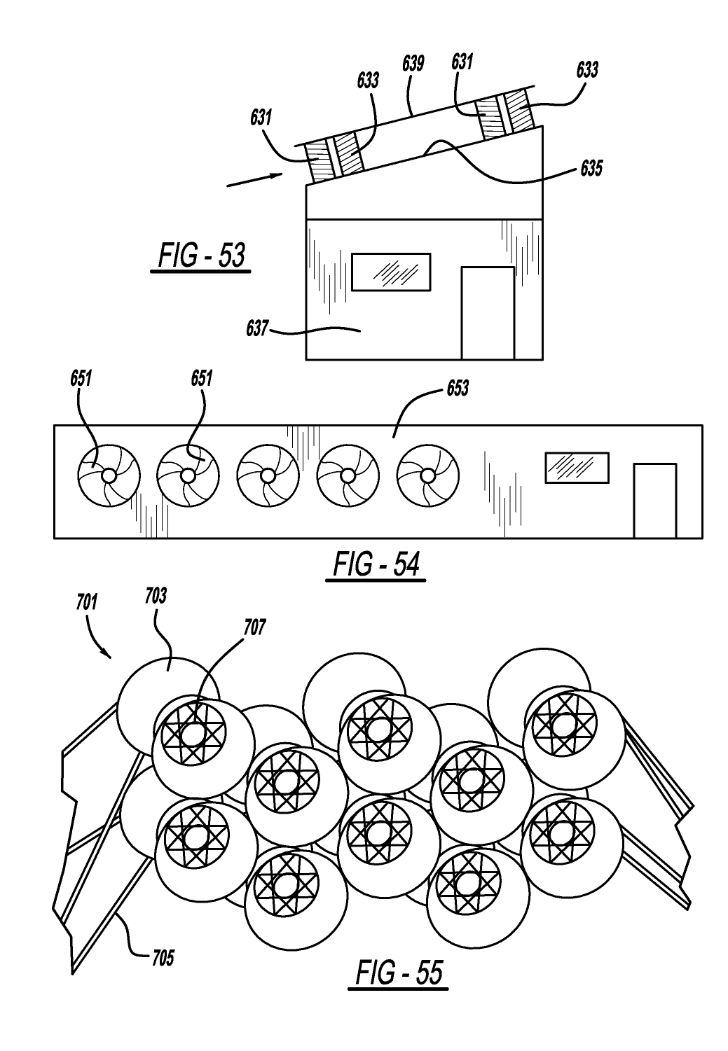

Referring now to FIG. 53, a different wind turbine embodiment mounts counter-rotating pairs of rotors 631 and 633 on top of a sub-roof 635 of a building 637. Airflow channels are provided in the space between building sub-roof 635 and an outer housing or roof 639 so as to capitalize on wind airflow and/or natural convection currents therebetween. Hub driven or more preferably, peripherally driven power generation is employed with woven fiber rotors. The version shown in FIG. 54 mounts an array of woven fiber rotors 651 in an upstanding sidewall 653 of a building, such as a factory. Hub driven, or more preferably peripherally driven, power generators are used with rotors 561. These rotors 651 also advantageously reduce wind pressure on the building wall 653. For either of the embodiments of FIGS. 53 and 54, the rotors can be reversed (i.e., motor driven) to create ventilating airflow inside the building.

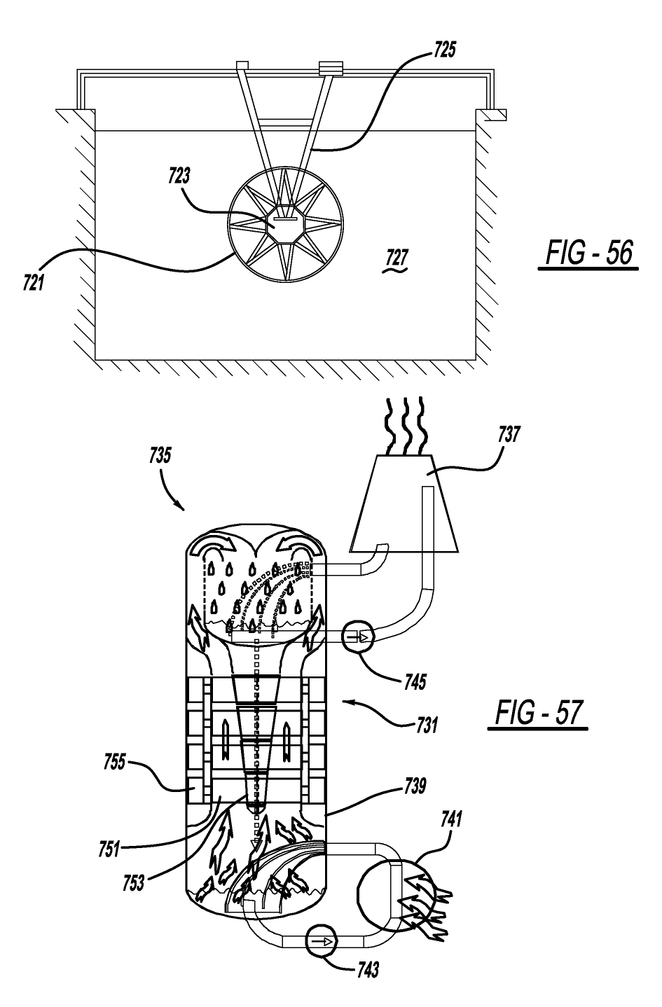

A water turbine use for the rotor apparatus 701 is illustrated in FIG. 55. Circularly shaped housings 703 of rotor apparatus 701 are clustered together and tethered by cables 705 to the ocean floor or otherwise floating in the ocean. Each rotor apparatus includes a continuous fiber woven rotor 707 surrounded by a peripheral stator which supplies electricity to an outgoing transmission line. This is useful for tidal seawater flow or water current flow in the ocean or rivers. Another tidal or current embodiment is illustrated in FIG. 56 wherein a continuous fiber rotor 721 has its hub 723 pivoting about and suspended by an overhanging gantry frame 725 within a waterway 727. In this version, a hub-driven electrical generator is employed.

Referring now to FIG. 57, a rotor apparatus 731 is part of a water purification system 735 which is useful for desalination of seawater, removal of dirt and contaminants from ground or surface water, and waste water treatment for sewage plants. System 735 includes a cooling tower 737, an evaporator tank-like housing 739 (having a vertical direction of elongation), a hydrogen production, integrated solar heat pump 741, and supplemental fluid pumps 743 and 745. At least two, and more preferably at least four, rotor apparatuses 731 are provided within housing 739. More specifically, continuous, resinated and stacked woven fiber rotors 751 are co-axially aligned and spin about aerodynamically tapered hubs 753, concentrically within stationary, peripheral stators 755. They act as compressors. The rotors and stators are made according to any of the embodiments disclosed herein and have alternating clockwise and counterclockwise rotational motions to move the condensing water vapor. Each rotor has wires or magnets adjacent a periphery thereof, which rotate within stationary concentric wires or magnets to act as electricity generators. U.S. Patent Publication No. 2010/0147673 entitled “Water Desalination System” is incorporated by reference herein.

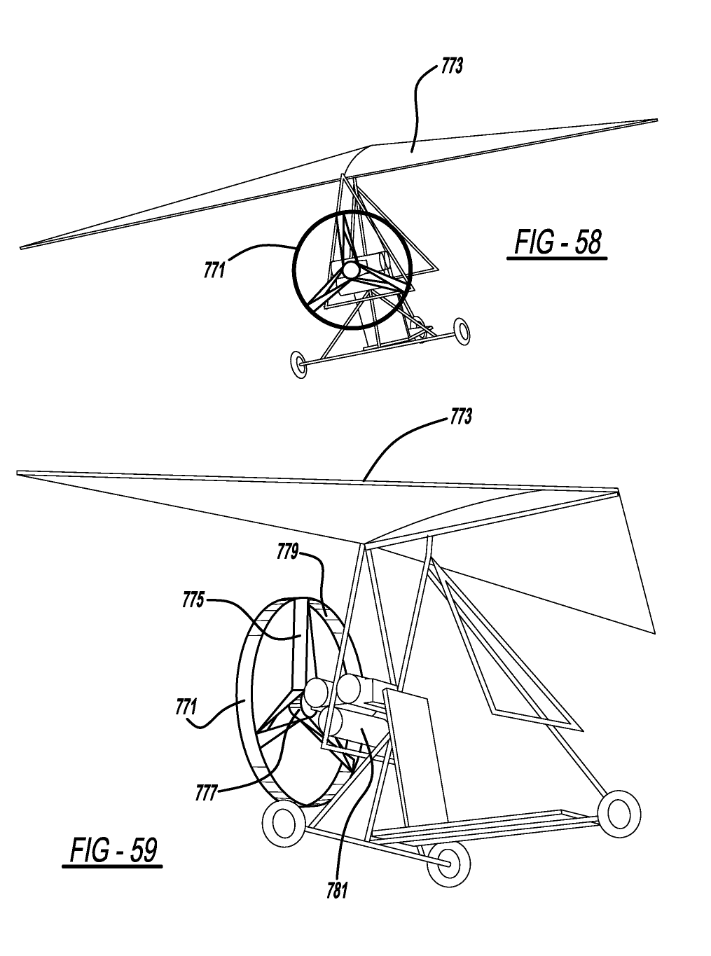

Finally, the embodiment shown in FIGS. 58 and 59 uses a rotor apparatus 771 to propel an aircraft 773 such as an ultralight airplane. Rotor apparatus 771 has multiple spaced apart radial blades 775 spanning between a central hub 777 and a peripheral circular shroud 779 in an integrated manner as discussed with any of the rotor embodiments herein. The rotor is hub-driven by an internal combustion motor 781 but could also be electrically driven with integrated motor. It is noteworthy that a single fiber defines an entire layer or pattern of the shroud and the blades with the fiber crossing itself in at least one intersection of the pattern. Since the rotor is not metallic coated, the lightweight nature of the resinated fiber rotor is highly beneficial in an aircraft situation where weight savings lead to fuel efficiency.

The woven composite impellers of the present invention are advantageous over prior compressor systems. The majority of forces seen by conventional impellers are not from the gas passing through the blades but from forces acting in its radial direction due to its own inherent mass rotating at high speeds. Thus, a lightweight and strong impeller overcomes this disadvantage. The lightweight nature of the present invention impellers reduce safety issues arising from using heavy materials and reduces the forces inflicted on the impeller bearings. The present invention lightweight materials also reduce the need for extensive balancing.

While many embodiments of woven rotors or impellers have been disclosed, other variations fall within the present invention. For example, one or more continuous and elongated strands or filaments are considered to fall within the disclosed term “fiber(s)”. The term “continuous” for a fiber is considered to be at least 5 cm, and more preferably at least 1 m in length and preferably long enough to constitute at least one entire pattern layer. Furthermore, weaving of one or more fibers has been disclosed, however, other fiber placement, stacking of layering techniques can be used, such as knitting, looping, draping, stitching and sewing. Additionally, multiple fibers or bundles of threads creating a fiber can be used as long as each fiber has a length of about 5 cm or longer in length (preferably much longer) and are placed in the desired orientations rather than having a chopped and substantially random fiber orientation. It should also be appreciated that conventional impeller manufacturing techniques, such as casting, molding machining or stamping can be used with certain aspects of the present invention condensing wave rotor system, however, many advantages of the present invention may not be realized. Moreover, ceramic or hybrid roller bearings, permanent magnetic bearings or active electromagnetic bearings can be used between each rotor and its surrounding housing. It is further envisioned that two or more radial wave rotors can be coaxially aligned and used together, preferably rotating at the same speed, or alternately at different speeds. Additionally, the woven and stacked fiber rotor can be employed in a manufacturing plant to create a vacuum in a pipe, such as 20-80 barr as part of a vacuum pump in a drier. The examples and other embodiments described herein are exemplary and are not intended to be limiting in describing the full scope of apparatus, systems, compositions, materials, and methods of this invention. Features of each embodiment can be interchanged with other embodiments disclosed herein. For example, a stator or rotor disclosed for geothermal use can alternately be used for natural gas compression, wind turbines, water turbines, water purification systems and/or aircraft propellers, or visa versa. Equivalent changes, modifications, variations in specific embodiments, apparatus, systems, compositions, materials and methods may be made within the scope of the present invention with substantially similar results. Such changes, modifications or variations are not to be regarded as a departure from the spirit and scope of the invention.

1. An apparatus comprising:
a rotor including at least one stacked fiber creating at least two blades;
a substantially circular member surrounding the blades; and
one of the following fluids passing inside of the substantially circular member and contacting against the blades:
(a) natural gas, wherein the rotor is adapted to compress the natural gas;
(b) geothermal fluid, wherein the geothermal fluid operably contacts the rotor when rotating;
(c) natural water flow, wherein the natural water current operably rotates the rotor to generate electricity;
(d) wind air flow, wherein the air flow operably rotates the rotor to generate electricity;
(e) water inside an evaporator tank, wherein rotation of the rotor assists in purifying the water from at least one of: (i) contaminants or (ii) salt;
(f) CO₂ fluid, wherein the rotor is adapted to compress the CO₂ fluid;
(g) ammonia, wherein the rotor is adapted to compress the ammonia;
(h) methane, wherein the rotor is adapted to compress the methane; or
(i) air, wherein the rotor is adapted to create vacuum pressure by evacuating the air.

2. The apparatus of claim 1, further comprising a fluid coolant passageway located adjacent the rotor.

3. The apparatus of claim 2, wherein the coolant passageway includes arms
radially extending from a central structure, the central structure is aligned with a rotational axis of the rotor, and coolant fluid is emitted from apertures in the arms.

4. The apparatus of claim 1, further comprising:
magnetic material attached to the substantially circular member rotating with the blades, the member being a shroud attached to the blades; and
a stationary stator surrounding the substantially circular member, the stator including wire windings.

5. The apparatus of claim 2, wherein the coolant passageway is a hollow annular jacket surrounding a section of the stator, the jacket has a continuous hollow length at least four times greater than its width, and its length is parallel to a rotational axis of the rotor.

6. The apparatus of claim 2, wherein the coolant passageway includes integrally formed and elongated voids in a polymer encapsulating inwardly projecting teeth and the wire windings of the stator.

7. The apparatus of claim 1, further comprising at least one pipe aligned with at least two of the rotors for carrying the fluid which is the natural gas, a first of the rotors rotating in a clockwise direction and a second of the rotors rotating in a counterclockwise direction.

8. The apparatus of claim 7, wherein there are at least four of the rotors which are coaxially aligned and rotate about a substantially horizontal axis, resin secures together adjacent stacked layers of the at least one fiber, and the rotor being corrosion resistant without an additional coating.

9. The apparatus of claim 7, wherein there are at least four of the rotors which are coaxially aligned and rotate about a substantially vertical axis, resin secures together adjacent stacked layers of the at least one fiber, and the rotor being corrosion resistant without an additional coating.

10. The apparatus of claim 1, wherein the fluid is natural gas, the substantially circular member is a shroud integrally formed with the blades, and the at least one fiber is also located in the shroud, further comprising polymeric resin securing the at least one fiber in the stacked configuration on the blades and shroud, and the fiber having a length of at least one meter.

11. The apparatus of claim 1, wherein the fluid is the geothermal fluid, further comprising a separator tank component is coupled to a condenser tank component which is coupled to a cooling tower component, and at least one of the components is accessible to fluid flow through the rotor.

12. The apparatus of claim 1, wherein the fluid is natural water flow, and multiples of the rotor are mounted in parallel beside each other positioned in a waterway spaced away from a bottom thereof such that the water can also flow between outsides of the rotors and the bottom of the waterway.

13. The apparatus of claim 1, wherein the fluid is the air flow, multiples of the rotor are mounted adjacent each other and tethered to the ground, and at least one of the rotors rotates clockwise and at least another of the rotors rotates counterclockwise.

14. The apparatus of claim 1, wherein the fluid is the water which from which at least one of: the contaminants or salt, is removed with the assistance of the rotor rotating inside the evaporator tank.

15. An apparatus comprising:
a rotor including at least one stacked fiber creating at least two blades; and
a natural gas carrying pipe, the rotor being in-line with the pipe, the pipe allowing natural gas to flow therethrough and through the rotor, and the rotor compressing natural gas in the pipe.

16. The apparatus of claim 15, further comprising multiples of the rotor are aligned with the pipe for compressing the natural gas, at least one of the rotors rotating in a clockwise direction and at least another of the rotors rotating in a counterclockwise direction.

17. The apparatus of claim 16, wherein at least four of the rotors are coaxially aligned and rotate about a substantially horizontal axis, and resin secures together adjacent stacked layers of the at least one fiber.

18. The apparatus of claim 16, wherein at least four of the rotors are coaxially aligned and rotate about a substantially vertical axis, and resin secures together adjacent stacked layers of the at least one fiber.

19. The apparatus of claim 15, wherein the rotor further comprises a shroud integrally formed with the blades, the at least one fiber is also located in the shroud, and the fiber is resinated and has a length of at least one meter.

20. The apparatus of claim 19, further comprising:
magnetic material attached to the shroud rotating with the blades; and
a stationary stator surrounding the shroud, the stator including wire windings.

21. The apparatus of claim 15, further comprising a fluid coolant passageway located adjacent the rotor.

22. The apparatus of claim 21, wherein the coolant passageway includes radial arms extending from a central structure aligned with a rotational axis of the rotor, and coolant fluid is emitted from apertures in the arms.

23. The apparatus of claim 15, further comprising multiple modularized housings, each including a rotor with at least one stacked continuous fiber creating at least two blades, each of the housings further including a stator surrounding a corresponding one of the rotors, each of the housings being removable from the otherwise coaxially aligned multiple of the housings, and the natural gas sequentially flowing through the housings to contact against the rotor blades therein then into the pipe.

24. The apparatus of claim 15, wherein the at least one fiber crosses itself and defines at least a complete layer of the rotor, further comprising polymeric resin free of a metallic coating securing together layers of the at least one fiber.

25. An apparatus comprising:
a rotor including at least one stacked fiber creating at least two blades; and
a pipe, the rotor being in-line with the pipe, ends of the pipe allowing geothermal fluid to flow therethrough such that the geothermal fluid contacts the blades of the rotor.

26. The apparatus of claim 25, further comprising a stator, and a fluid coolant passageway located adjacent at least one of the rotor and the stator.

27. The apparatus of claim 26, wherein the coolant passageway includes radial arms extending from a central pivot, a hub of the rotor is rotatably coupled to the pivot, and coolant fluid is emitted from apertures in the arms.

28. The apparatus of claim 25, wherein the rotor further comprises a shroud integrally formed with the blades, the at least one fiber also being located in the shroud, polymeric resin securing the at least one fiber in the stacked configuration on the blades and shroud, the fiber having a length of at least one meter, and the rotor being corrosion resistant without requiring a specific corrosion resistant coating or metal on the blades.

29. The apparatus of claim 25, further comprising:
magnetic material attached to the rotor; and
a stationary stator surrounding the rotor, the stator including wire windings, the fluid flowing internally through the stator.

30. The apparatus of claim 25, further comprising at least two of the rotors are aligned with the pipe for compressing noncondensable gas of the geothermal fluid, at least one of the rotors rotating in a clockwise direction and at least another of the rotors rotating in a counterclockwise direction.

31. The apparatus of claim 25, further comprising multiple modularized housings, each including a rotor with at least one stacked continuous fiber creating at least two blades, each of the housings further including a stator surrounding a corresponding one of the rotors, each of the housings being removable from the otherwise coaxially aligned multiple of the housings, and the geothermal fluid flowing from the pipe then sequentially through the housings to contact against the rotor blades therein.

32. The apparatus of claim 25, wherein the at least one fiber crosses itself and defines at least a complete layer of the rotor, further comprising polymeric resin free of a metallic coating securing together layers of the at least one fiber.

33. An apparatus comprising:
a rotor including at least one stacked fiber to create at least two blades, and a peripheral shroud surrounding the blades also being created by the at least one stacked fiber, the shroud rotating with the blades;
a housing having the rotor located therein, ends of the housing being adapted to allow water to flow therethrough such that natural current and/or tidal movement of the water rotate the rotor;
at least one magnetic member attached to one of the rotor and housing;
at least one electrically conductive member attached to the other of the rotor and the housing, such that rotation of the rotor generates electricity; and
a member tethering the housing, submerged in a body of the water, to a stationary base.

34. The apparatus of claim 33, wherein the at least one magnetic member includes multiple magnets attached to and substantially surrounding the shroud, and the at least one electrically conductive member includes a stator mounted to the housing, the stator concentrically surrounding the rotor.

35. The apparatus of claim 34, wherein the magnets are discrete and spaced apart, secured to a periphery of the stacked fiber shroud but not the blades, and the stator includes inwardly projecting teeth around which are wound electrically conductive wire windings.

36. The apparatus of claim 33, further comprising polymeric resin securing the at least one fiber in the stacked configuration on the blades and shroud, and the fiber having a length of at least one meter.

37. The apparatus of claim 33, wherein multiples of the rotors are mounted in parallel beside each other positioned in a waterway spaced away from a bottom thereof such that the water can also flow between outsides of the rotors and the bottom of the waterway, and the base is located on the bottom of waterway, further comprising a wing or drag ring laterally projecting from the housing to control orientation or positioning of the housing in the waterway.

38. The apparatus of claim 33, wherein:
the at least one fiber crosses itself and defines at least a complete layer of the rotor, further comprising polymeric resin free of a metallic coating securing together layers of the at least one fiber; and
the at least one electrically conductive member is a substantially annular stator including inwardly projecting teeth wrapped with wire windings which are encapsulated in a polymer, and the water flows through a middle of the stator.

39. The apparatus of claim 33, wherein a center of the rotor is open to allow sealife movement therethrough during rotation of the rotor.

40. The apparatus of claim 33, wherein:
the housing has a circular peripheral shape throughout its entirety;
the shroud is circular;
and the blades define a star shape;
further comprising at least six of the housings being mounted to each other with the rotors therein all rotating about parallel axes.

41. An apparatus comprising:
a rotor including at least one stacked fiber to create at least two blades, and a peripheral shroud surrounding the blades also being created by the at least one stacked fiber, the shroud rotating with the blades;
a housing having the rotor located therein, ends of the housing being adapted to allow air to flow therethrough such that the air flow rotates the rotor;
at least one magnetic or inductive member attached to one of the rotor and housing; and
at least one electrically conductive member attached to the other of the rotor and the housing, such that rotation of the rotor generates electricity.

42. The apparatus of claim 41, further comprising an aircraft member causing the housing to be airborne and a tether anchoring the member to a stationary base.

43. The apparatus of claim 41, wherein the at least one magnetic member includes multiple magnets attached to and substantially surrounding the shroud, and the at least one electrically conductive member includes a stator mounted to the housing, the stator concentrically surrounding the rotor.

44. The apparatus of claim 41, wherein multiples of the rotors are mounted adjacent each other, and a first of the rotors rotates clockwise and a second of the rotors rotates counterclockwise.

45. The apparatus of claim 41, wherein the at least one fiber crosses itself and defines at least a complete layer of the rotor, further comprising polymeric resin securing together layers of the at least one fiber, and the at least one fiber constituting at least a majority of the structure of the blades and shroud.

46. The apparatus of claim 41, further comprising a stationary building having a roof and a sidewall, the housing being mounted to or defined by one of the roof and the sidewall.

47. The apparatus of claim 41, wherein the housing comprises a frustoconically shaped inlet channel between a leading opening and the rotor.

48. The apparatus of claim 41, further comprising a rigid and substantially vertically elongated mast supporting a substantially horizontal rotational axis about which the rotor rotates due to air contact against the blades.

49. The apparatus of claim 41, further comprising aerodynamic lift floating the housing above the ground, and a flexible tether securing the housing to the ground.

50. An apparatus comprising a rotor including at least one stacked fiber to create at least two blades, and a peripheral shroud surrounding the blades also being created by the at least one stacked fiber, the shroud being attached to and rotating with the blades, the fiber being at least one meter long and creating at least one entire layer of the blades and shroud, and air flow contact against the blades and within the shroud causing the rotor to rotate and generate electricity.

51. The apparatus of claim 50, further comprising a rigid and substantially vertically elongated mast supporting a substantially horizontal rotational axis about which the rotor rotates due to air contact against the blades.

52. The apparatus of claim 50, wherein there are only three of the blades in the rotor, and a majority of each blade consists of the at least one fiber.

53. The apparatus of claim 50, further comprising a housing surrounding the rotor, and a wing or drag ring laterally projecting from the housing to control orientation or positioning of the housing as it floats above the ground.

54-74. (canceled)

75. A method of using a rotor, the method comprising:
(a) contacting natural gas or geothermal fluid against stacked fiber and resin blades of a rotor, the rotor including a shroud coupled to the blades; and
(b) rotating the rotor as the natural gas or geothermal fluid moves through the rotor inside the shroud.

76. The method of claim 75, further comprising:
(a) rotating the rotor inside a stator;
(b) rotating a magnetic material with the rotor; and
(c) passing electromagnetism between the rotor and stator.

77. The method of claim 75, further comprising generating electricity by the rotation of the rotor.

78. The method of claim 75, wherein the rotor compresses the natural gas or geothermal fluid.

79. The method of claim 75, further comprising spraying a coolant liquid toward the rotor during the rotation.

80. The method of claim 75, wherein the fiber is at least one meter long and creates at least one entire stacked layer of the rotor including the shroud and all the blades.
